(19) United States
(12) Patent Application Publication
(10) Pub. No.: US 2015/0049759 A1
(43) Pub. Date: Feb. 19, 2015

(54) NODE APPARATUS, DATA RELAY METHOD AND COMPUTER-READABLE RECORDING MEDIUM

(71) Applicant: FUJITSU LIMITED, Kawasaki-shi (JP)

(72) Inventors: Mitsuhiro Noyama, Fukuoka (JP); Kenji MAEDA, Kasuga (JP); Kazuhisa Matsumoto, Fukuoka (JP); Yoshinobu Shimokawa, Itoshima (JP); Katsuhiko Yamatsu, Fukuoka (JP); Koki Mie, Fukuoka (JP); Yuji HIGASHIHARA, Fukuoka (JP)

(21) Appl. No.: 14/331,290

(22) Filed: Jul. 15, 2014

(30) Foreign Application Priority Data
Aug. 14, 2013 (JP) 2013-168444

(51) Int. Cl. H04L 12/755

(52) U.S. Cl. CPC H04L 45/021
USPC 370/389

(57) ABSTRACT

A node apparatus includes a receiving unit receiving a data frame from one of adjacent nodes apparatuses; a storing unit storing an identification information management table in which frame identification information with which the data frame may be uniquely identified, and overlapped data identification information; a processor which performs a process including: judging whether or not a final destination of the received data frame is the node apparatus itself; judging whether or not a registration that matches the frame identification information of the received data frame exists in the identification information management table; judging whether or not the overlapped data identification information of the received data frame and the overlapped data identification information corresponding to the registration match; and discarding the received data frame; and performing a retransmission of the received data frame to another adjacent node that has not been a transmission destination of the data frame.

### CROSS-REFERENCE TO RELATED APPLICATION

This application is based upon and claims the benefit of priority of the prior Japanese Patent Application No. 2013-168444, filed on Aug. 14, 2013, the entire contents of which are incorporated herein by reference.

### FIELD

The present invention relates to a node apparatus, a data relay method, and a computer-readable recording medium.

### BACKGROUND

In recent years, studies of ad-hoc networks in which a plurality of wireless communication apparatuses (hereinafter, referred to as node apparatuses) connect to each other in an autonomously distributed manner have been carried out. Each of the node apparatuses of an ad-hoc network independently establish a network according to the communication environment.

Specifically, in the ad-hoc network, no access points are provided, and each of the node apparatuses relays to another adjacent node apparatus a data frame received from a node apparatus that is adjacent to it (hereinafter, referred to as an adjacent node apparatus) on the basis of the network topology, to transmit the data frame to the destination node apparatus. At this time, each of the node apparatuses transmits the data frame by selecting a path with a better transmission quality.

Because the network environment changes from to time, even when each of the node apparatuses transmits the frame on the basis of the network topology, the frame is not always transmitted to its destination node apparatus.

For example, even when the transmission of the data frame from a node apparatus to an adjacent node apparatus has been successful, for a certain reason (for example, a communication failure), an ACK (ACKnowledgment) frame sent back from the adjacent node apparatus may be missing.

In this case, the node apparatus that has transmitted the data frame determines that the transmission of the data frame has failed, and it re-transmits the data frame to another adjacent node apparatus. As a result, a plurality of the same data frames (hereinafter, referred to as overlapped data) are transmitted through the network. Therefore, the detection of overlapped data is very important.

As a technique related to the ad-hoc network, a method to detect whether or not the node apparatus has received the same data frame as a data frame received previously has been known.
Japanese Laid-open Patent Publication No. 2007-19574

### SUMMARY

A node apparatus according to an aspect includes a receiving unit which receives a data frame from one of a plurality of adjacent node apparatuses with which links exist; a storing unit which stores an identification information management table in which frame identification information with which the data frame may be uniquely identified, and overlapped data identification information with which, when data frames having the same frame identification information are received in an overlapped manner, the data frame received first among the overlapped data frames may be uniquely identified, are associated; a processor which performs a process including: first judging whether or not a final destination of the received data frame is the node apparatus itself; second judging, when the final destination of the received data frame is not the node apparatus itself, whether or not a registration that matches the frame identification information of the received data frame exists in the identification information management table; third judging, when it is determined by the second judging that the registration exists in the identification information management table, whether or not the overlapped data identification information of the received data frame and the overlapped data identification information corresponding to the registration match; and discarding the received data frame when a judgment of a mismatch is made by the third judging; and performing a retransmission of the received data frame to another adjacent node that has not been a transmission destination of the data frame, when a judgment of a match is made by the third judging.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a conceptual diagram of a network in embodiment 1.

FIG. 2 is a functional block diagram illustrating a configuration example of a node apparatus that constitutes a network in embodiment 1.

FIG. 3 is a diagram illustrating a format example of the header of a data frame in embodiment 1.

FIG. 4 is the explanation of each field in the format example illustrated in FIG. 3.

FIG. 5 is a diagram illustrating an example of a FID table in embodiment 1.

FIG. 6 is a diagram illustrating an example of a routing table.

FIG. 7 is a portion of an example of a flowchart for explaining the flow of a relay process in embodiment 1.

FIG. 8 is another portion of the example of the flowchart for explaining the flow of a relay process in embodiment 1.

FIG. 9 is an example of a flowchart for explaining the flow of a retry process in embodiment 1.

FIG. 10 is a timing chart corresponding to the example illustrated in FIG. 1.

FIG. 11 is a diagram illustrating the contents of the header and the FID table at the respective timing of the timing chart in FIG. 10.

FIG. 12 is a conceptual diagram of a network in embodiment 2.

FIG. 13 is a functional block diagram illustrating a configuration example of a node apparatus that constitutes a network in embodiment 2.

FIG. 14 is a diagram illustrating a format example of the header of a data frame in embodiment 1.

FIG. 15 is the explanation of each field in the format example illustrated in FIG. 14.

FIG. 16 is a diagram illustrating an example of a FID table in embodiment 2.

FIG. 17 is a diagram illustrating an example of a retry management table.

FIG. 18 is a portion of an example of a flowchart for explaining the flow of a relay process in embodiment 2.

FIG. 19 is another portion of the example of the flowchart for explaining the flow of a relay process in embodiment 2.

FIG. 20 is a portion of an example of a flowchart for explaining the flow of a retry process in embodiment 2.

FIG. 21 is another portion of an example of a flowchart for explaining the flow of a retry process in embodiment 2.

FIG. 22 is a timing chart corresponding to the example illustrated in FIG. 12.

FIG. 23 is a diagram illustrating the contents of the header and the FID table at the respective timings of the timing chart in FIG. 22.

FIG. 24 is a timing chart corresponding to another example in a network illustrated in FIG. 12.

FIG. 25 is a diagram illustrating the contents of the header and the FID table at the respective timings of the timing chart in FIG. 24.

FIG. 26 is a portion of a flowchart for illustrating the flow of a relay process in embodiment 3.

FIG. 27 is a diagram illustrating an example of the hardware configuration of a node apparatus in an embodiment.

### DESCRIPTION OF EMBODIMENTS

Hereinafter, embodiments of the present invention are described in detail with reference to the drawings.

Embodiment 1 is described.

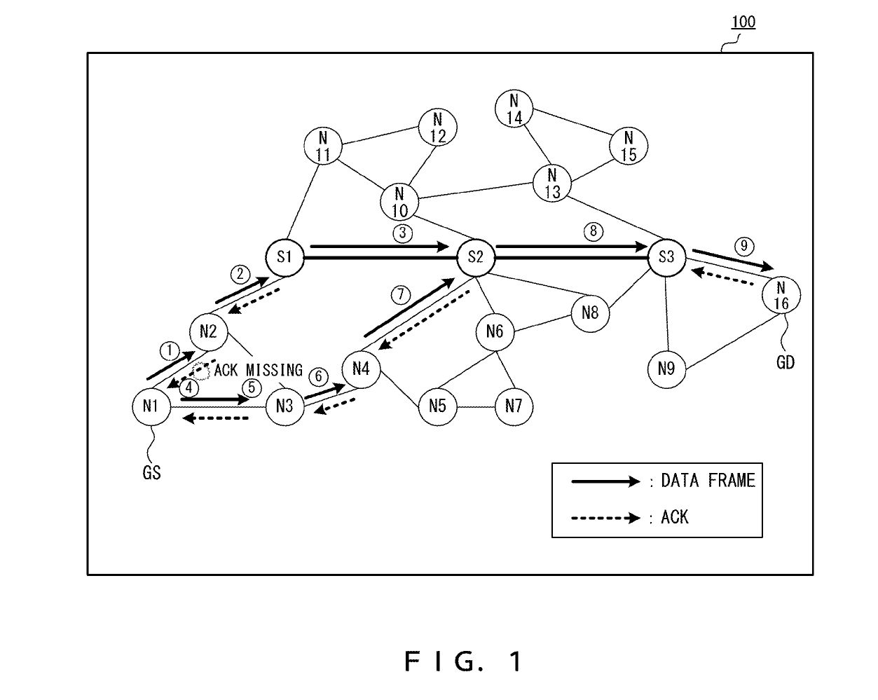

FIG. 1 is a diagram illustrating a configuration example of a network 100 in embodiment 1. The network 100 is an example of an ad-hoc network, and includes a plurality of node apparatuses 1. Between the node apparatuses 1, links exist, and the links are expressed with solid lines in FIG. 1.

In the present embodiment 1, there are at least two types of node apparatuses 1 that constitute the network 100. One is an “end node apparatus”, and the other one is a “relay node apparatus”.

The end node apparatus 1 is, for example, a sensor node apparatus and the like equipped with a metering node apparatus such as a power meter and various sensors. The end node apparatus 1 is an apparatus that collects information from the sensor and the like according to the order from a data server or independently, and transmits the collected information (data frame) to the data server.

The end node apparatus 1 is, in FIG. 1, indicated as “Ni” (i=1, . . . , 16). “Ni” is a node ID (IDentification) with which the end node apparatus 1 may be uniquely identified.

The relay node apparatus 1 is a node apparatus exclusively for performing relaying with a stronger wave output and a higher transmission rate compared with the end node apparatus 1, and relays the data frame transmitted by the end node apparatus 1. The relay node apparatus 1 is, for example, placed in a case such as when there is a distance between adjacent end node apparatuses 1, and it is impossible to constitute the network 100 only with the end node apparatuses 1. That is, as the network 100 illustrated in FIG. 1, a network in an area with scattered houses such as in a mountainous area may be expected.

The relay node apparatus 1 in FIG. 1 is indicated as “Sj” (j=1, 2, 3). “Sj” is a node ID with which the relay node apparatus 1 may be uniquely identified.

Meanwhile, in the present embodiment 1, the configuration is made so that when the relay node apparatus 1 transmits a data frame to another relay node apparatus 1, the other noted apparatus 1 that has received the data frame does not send back the ACK frame.

The link may be either a wireless link or a wired link. For example, referring to FIG. 1, when the end node apparatus N1 and the end node apparatus N2 may communicate directly without relay by another node apparatus 1, this is expressed as “a link exists between the end node apparatus N1 and the end node apparatus N2”.

The link changes dynamically, and due to the influence of the weather, shielding objects and the like, a new link may be established between the node apparatuses 1, and a link that has been established may disappear. In addition, for example, when the node apparatus 1 is mobile, the presence/absence of the link may change due to the variation in the distance between the node apparatuses 1. In addition, for example, due to the change in the cable connection, a new link may be established between the node apparatuses 1, a link that has been established may disappear, and due to a failure such as the cutting of the cable, a link may disappear.

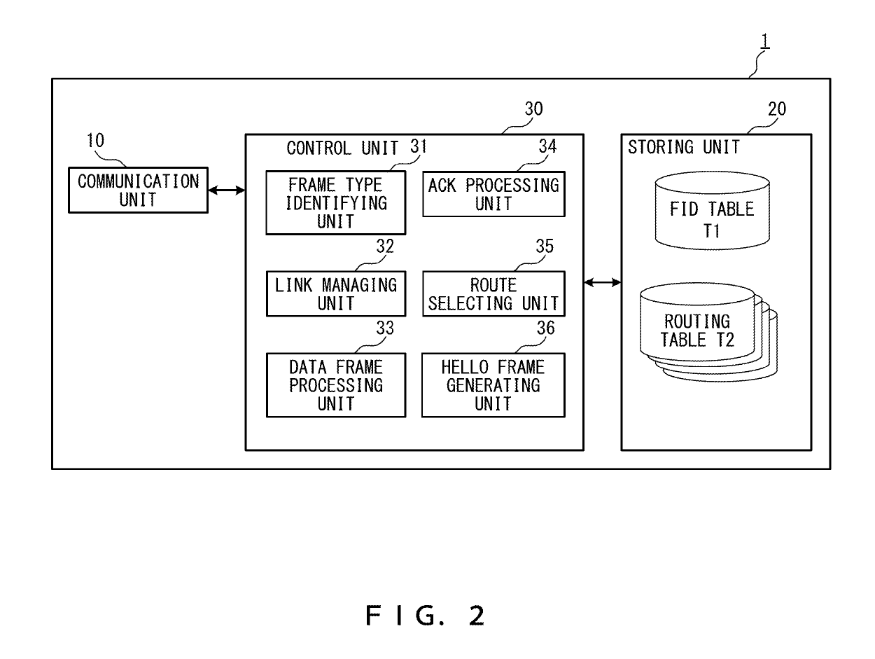

Next, referring to FIG. 2, the node apparatus 1 in the present embodiment 1 is explained.

FIG. 2 is a functional block diagram illustrating a configuration example of the node apparatus 1 constituting the network 100 in the present embodiment 1.

The node apparatus 1 includes a communication unit 10, a storing unit 20, and a control unit 30.

The communication unit 10 is constituted by a communication module and the like, and performs communication with another node apparatus 1. For example, the communication unit 10 transmits/receives a frame.

The storing unit 20 is constituted by a RAM (Random Access Memory), a ROM (Read Only Memory), a flash memory, and the like. The storing unit i20 constitutes the control unit 30. For example, it functions as a work area of the MPU (Micro-Processing Unit), a program area to store various programs such as the operation program to control the entire node apparatus 1, a data area to store various data such as a FID table T1, a routing table T2 whose details are described later, and the like. In addition, in the data area, the node ID of the node apparatus itself and the attribute information of the node apparatus 1 itself (for example, information indicating the type of the node apparatus) are also stored.

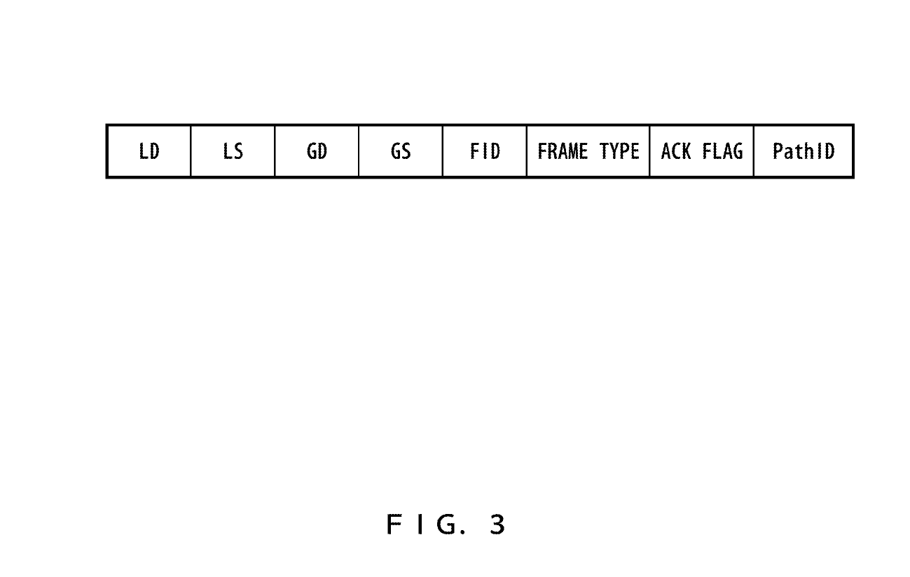

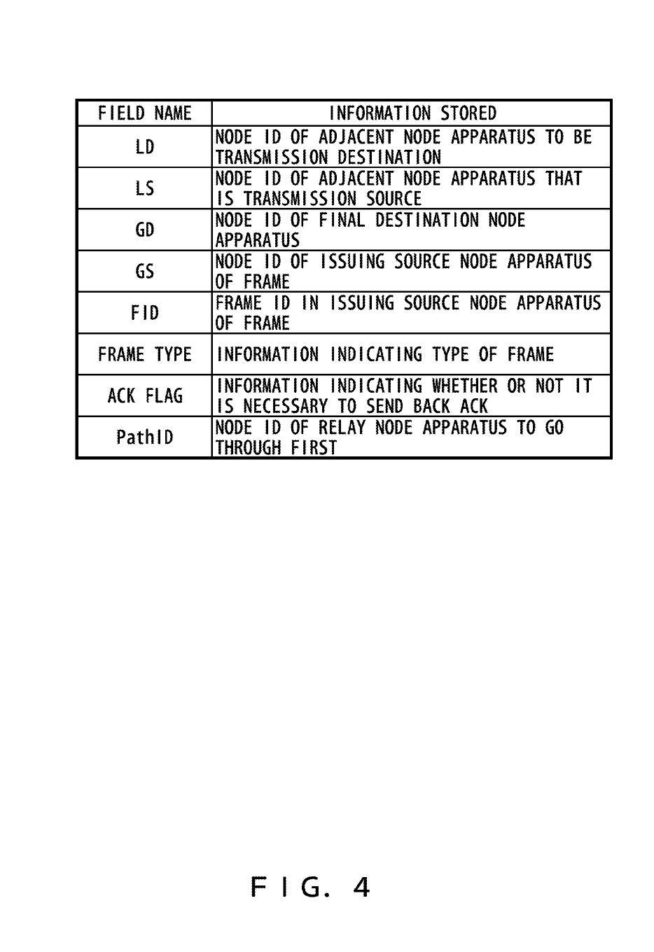

Here, referring to FIG. 3 and FIG. 4, the header of the data frame generated by a data frame processing unit 33 (details are described later) is explained. FIG. 3 is a diagram illustrating a format example of the header of the data frame in the present embodiment 1. FIG. 4 is the explanation of each field in the format example illustrated in FIG. 3.

The header of the data frame in the present embodiment 1 includes, as illustrated in FIG. 3, LD (Local Destination), LS (Local Source), GD (Global Destination), GS (Global Source), FID (Frame IDentification), frame type, ACK flag, and PathID.

The LD is the node ID of the adjacent node apparatus 1 to be the transmission destination, and a route selecting unit 35 (details are described later) selects the LD referring to a routing table T2. For example, referring to FIG. 1, the LD of the data frame transmitted by the end node apparatus N1 to the end node apparatus N2 is N2.

The LS is the node ID of the adjacent node apparatus of the transmission source, and the data frame processing unit 33 of the node apparatus 1 to be the LS stores the node ID of the node apparatus itself in the LS field. For example, referring to FIG. 1, the LS of the data frame transmitted by the end node apparatus N1 to the end node apparatus N2 is N1.

The GD is the node ID of the node apparatus 1 to be the final destination. The GS is the node ID of the node apparatus 1 of the issuing source of the data frame (hereinafter also referred to as issuing source node apparatus). For example, referring to FIG. 1, when a data frame issued by the end node apparatus N1 is relayed in the order of the relay node apparatus S2 and the relay node apparatus S3, and transmitted finally to the end node apparatus N16, the GD of the data frame is N16, and its GS is N1.

Meanwhile, hereinafter, when a data frame issued by the end node apparatus N1 is relayed in the order of the end node apparatus N2, the relay node apparatus S1, the relay node apparatus S2, and the relay node apparatus S3, and is transmitted finally to the end node apparatus N16, it is expressed as path <N1, N2, S1, S2, S3, N16>.

The FID is the frame ID in the issuing source node apparatus 1 of the frame. That is, the FID generated by the issuing source node apparatus 1 is stored in the “FID” field of the header. That is, by combining the GS and FID, it becomes frame identification information with which the frame may be uniquely identified.

The frame type is information indicating the type of the frame, and in a data frame, information indicating that the type of the frame is the data frame is stored in the “frame type” field. As the types of the frames, in the present embodiment 1 at least, there are three, including the hello frame, the data frame and the ACK frame (hereinafter simply referred to as ACK).

The hello frame is generated by a hello frame generating unit 36 (details are described later), and is a frame for notifying other node apparatuses 1 of the existence of the node apparatus 1 itself, and includes information necessary for the path generation. The data frame is a frame including information that the issuing source node apparatus 1 (GS) is trying to send as the payload to the node apparatus 1 (GD) to be the final destination. The ACK is a frame for notifying the node apparatus 1 (LS) of the transmission source of the reception of the data frame.

The ACK flag is information (flag) indicating whether or not it is necessary to send back the ACK to the LS in response to the reception of the data frame. For example, when the value stored in the “ACK flag” is “0”, this indicates that the sending back of the ACK is necessary, and on the other hand, when it is “1”, this indicates that the sending back of the ACK is unnecessary. Meanwhile, in the present embodiment 1, the initial value of the ACK flag is “0”. That is, when the end node apparatus 1 generates a data frame as the GS, the data frame processing unit 33 of the end node apparatus 1 sets the value of the ACK flag to “0”.

The PathID is the node ID of the relay node apparatus that the data frame goes through first (hereinafter, referred to as a first relay node apparatus), and the data frame processing unit 33 of the first relay node apparatus 1 stores the node ID of the node apparatus 1 itself in the “PathID” field. For example, referring to FIG. 1, when the path of the data frame is path <N1, N2, S1, S2, S3, N16>, the first relay node apparatus 1 is the relay node apparatus S1, and therefore, the PathID is S1.

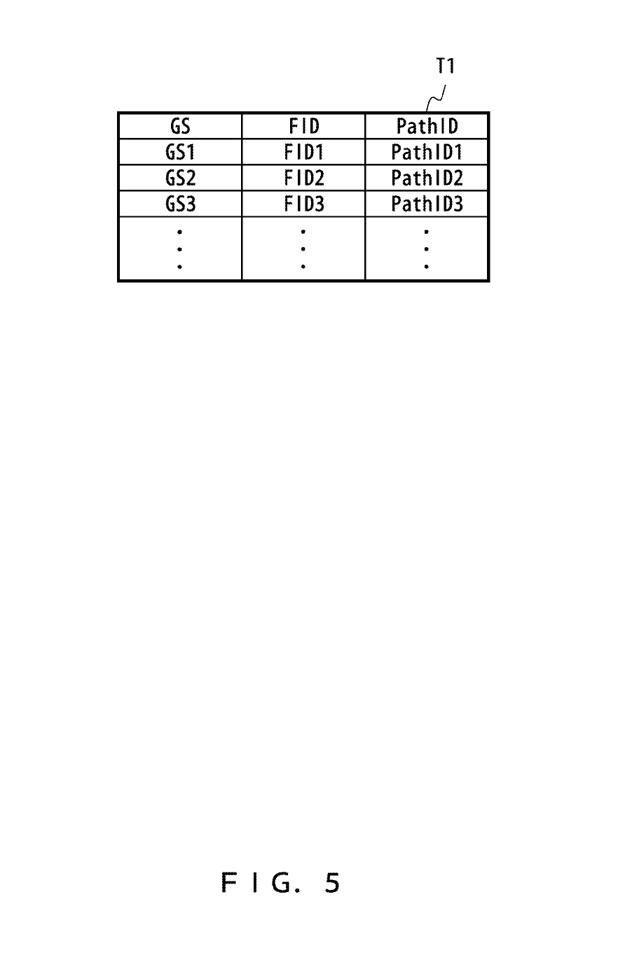

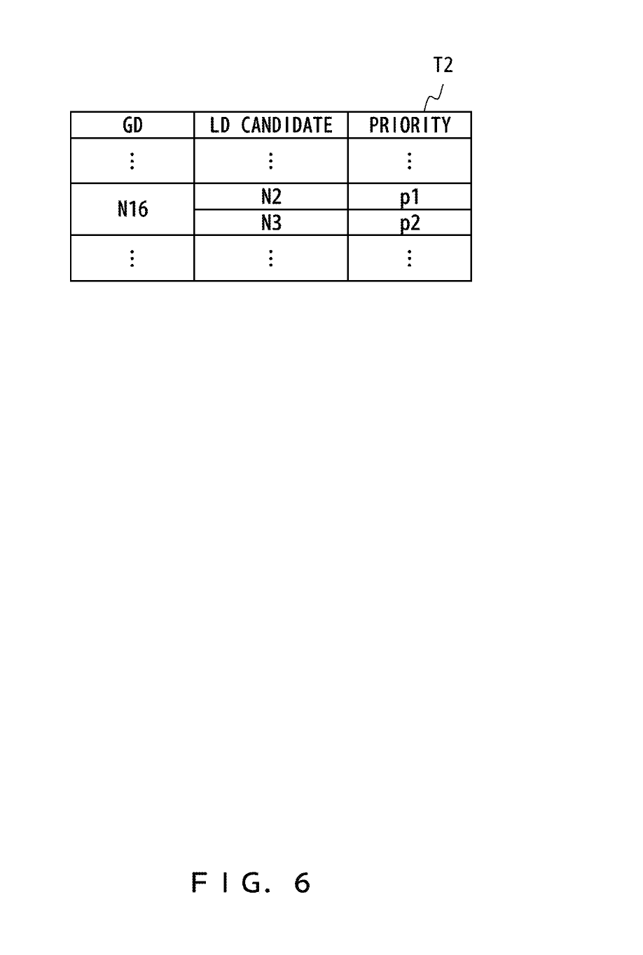

Next, referring to FIG. 5 and FIG. 6, an FID table T1 and a routing table T2 stored in the data area of the storing unit 20 are respectively explained.

FIG. 5 is a diagram illustrating an example of the FID table T1 in the present embodiment 1. The FID table T1 in the present embodiment 1 is managed by the data frame processing unit 33, and as illustrated in FIG. 5, is a table in which “GS”, “FID”, and “PathID” are associated.

FIG. 6 is a diagram illustrating an example of the routing table T2. The routing table T2 is managed by a link managing unit 32 (details are described later), and is a table managing information required for selecting the adjacent node apparatus 1 to which the data frame is to be transmitted, for each GD. For example, the routing table T2 is a table in which, as illustrated in FIG. 6, for each GD, “LD candidate” and “priority” are associated.

Meanwhile, the routing table T2 illustrated in FIG. 6 is an example of the routing table T2 that the end node apparatus N1 stores, and it is assumed that priority P1 is set to be higher than priority p2.

The “LD candidate” is the node ID of the adjacent node apparatus 1 with which the link exists. The “priority” indicates the priority in selecting the LD from LD candidates. This priority may be variable, and for example, the configuration may be made so that the link managing unit 32 changes the priority on the basis of whether or not the transmission of the data frame has been successful. In addition, for example, the configuration may be made so that the link managing unit 32 changes the priority on the basis of whether or not the data frame transmitted to the adjacent node apparatus 1 has been looped or not.

Returning to FIG. 2, the control unit 30 is constituted by, for example, an MPU or the like, and executes the operation program stored in the program area of the storing unit 20, to realize functions, as illustrated in FIG. 2, as the frame type identifying unit 31, the link managing unit 32, the data frame processing unit 33, the ACK processing unit 34, the route selecting unit 35, and the hello frame generating unit 36, and also executes processes such as a control process to control the entirety of the node apparatus and a relay process whose details are described later, and the like.

The frame type identifying unit 31 identifies the type of the frame received at the communication unit 10. Specifically, upon receiving a frame, the communication unit 10 outputs the received frame to the frame type identifying unit 31. Then, the frame type identifying unit 31 analyzes the header of the received frame, and on the basis of the frame type, identifies the type of the frame.

Then, when the identified type of the frame is a hello frame, the frame type identifying unit 31 outputs the received frame to the data frame processing unit 33, and when the type of the identified frame is the ACK, outputs the received frame to the ACK processing unit 34.

The link managing unit 32 manages the routing table T2. More specifically, when the received frame is the hello frame, the link managing unit 32 analyzes the received hello frame, and on the basis of the analysis result, performs the update and generation of the routing table T2. Meanwhile, when an instruction to generate the routing table T2 is input from the route selecting unit 35, the link managing unit 32 generates the routing table T2 corresponding to the GD for which the generation has been instructed, for example on the basis of the hello frame received in the past.

In addition, the link managing unit 32 changes the priority of the routing table T2 on the basis of the result of the judgment as to whether or not the transmission of the data frame transmitted by the ACK processing unit 34 was successful, and the like. For example, when it is determined that the transmission of the data frame has failed, the link managing unit 32 sets the priority corresponding to the “LD candidate” for which the transmission of the data frame has been determined as failed as the lowest.

The data frame processing unit 33 performs processing of the received data frame. More specifically, the data frame processing unit 33 first judges whether or not a data frame has been received by judging whether or not a data frame has been input by the frame type identifying unit 31. Then, upon receiving a data frame, the data frame processing unit 33 analyzes the header of the received data frame, and judges whether or not the LD matches the node ID of the node apparatus itself. Then, when the LD does not match the node ID of the node apparatus itself, the data frame processing unit 33 discards the received data frame, and when the LD matches the node ID of the node apparatus itself, on the basis of the ACK flag, judges whether or not it is necessary to send back the ACK to the LS.

When it is necessary to send back the ACK to the LS, the data frame processing unit 33 issues an instruction to generate the ACK to the ACK processing unit 34. Then, the data frame processing unit 33 judges whether or not the GD matches the node ID of the node apparatus itself. That is, the data frame processing unit 33 judges whether the final destination of the received data frame is its node apparatus 1 itself or not.

When the final destination of the received data frame is its node apparatus 1 itself, the data frame processing unit 33 outputs the received data frame to the upper-level layer. In response to the input of the data frame, the upper-level layer performs processing of the received data frame.

On the other hand, when the final destination of the received data frame is another node apparatus 1, the data frame processing unit 33 compares the header and the FID table T1, and judges whether or not there is a registration in the FID table T1 whose combination of the GD and FID matches the combination of the GD and FID of the header. That is, the data frame processing unit 33 judges whether or not the same data frame has already been received.

When there is a registration in the FID table T1 whose combination of the GD and FID matches the GD and the FID of the header and its node apparatus 1 itself is the relay node apparatus 1, the data frame processing unit 33 further judges whether or not the PathID of the header matches the PathID of the registration whose combination of the GD and FID matches the combination of the GD and FID of the header. That is, it judges whether or not there is any registration in the FID table T1 that matches the combination of the GD and FID and the PathID of the header.

When there is a registration in the FID table T1 that matches the combination of the GD and FID and the PathID of the header, the data frame processing unit 33 determines that the received data frame is loop data. On the other hand, when there is a registration in the FID table T1 that matches the combination of the GD and FID of the header but the PathID does not match, the data frame processing unit 33 determines that the received data frame is overlapped data. As described above, in the present embodiment 1, it is possible to distinguish between loop data and overlapped data.

Then, upon determining that a received data frame is overlapped data, the data frame processing unit 33 discards the received data, and when it is determined as loop data, it issues an instruction to re-select the LD to the route selecting unit 35. At this time, the data frame processing unit 33 notifies the link managing unit 32 of the LD at the time of the transmission of the loop data and that the loop has been made. By doing so, it becomes possible for the link managing unit 32 to change the priority of the routing table T2 appropriately.

Meanwhile, even if there is a registration whose combination of the GD and the FID matches the combination of the GD and FID of the header, when its node apparatus 1 itself is the end node apparatus 1, the judgment as to whether the received data frame is loop data or overlapped data is not performed. That is, in the present embodiment 1, the distinguishing between loop data and overlapped data is executed only in the relay node apparatus 1. In the end node apparatus 1, when there is a registration in the FID table T1 whose combination of the GD and FID matches the combination of the GD and FID of the header, the received data frame is determined as loop data, and an instruction to re-select the LD is issued to the route selecting unit 35.

Meanwhile, when there are no registrations in the FID table T1 whose combination of the GD and FID match the combination of the GD and FID of the header, that is, when the data frame is received for the first time, the data frame processing unit 33 performs a registration process in the FID table T1.

More specifically, the data frame processing unit 33 judges whether or not the PathID of the header is null. When the PathID of the header is not null, that is, when the received data frame has gone through any relay node apparatus 1, the data frame processing unit 33 associates and registers the GD and the FID and the PathID of the header of in the FID table T1. Then, the data frame processing unit 33 issues an instruction to the route selecting unit 35 to perform transmission of the received data frame.

Meanwhile, when the PathID of the header is null, that is, when the received data frame is a data frame that has gone through no relay node apparatus 1 and its node apparatus 1 itself is the end node apparatus 1, the data frame processing unit 33 associates and registers the GD and the FID and the PathID of the header in the FID table T1. Then, the data frame processing unit 33 issues an instruction to select the LD, to perform transmission of the received data frame.

On the other hand, when the PathID of the header is null and its node apparatus 1 itself is the relay node apparatus 1, the data frame processing unit 33 sets the node ID of its node apparatus 1 itself to the PathID of the header, and also associates and registers the GD and the FID of the header in the FID table T1. That is, in the relay node apparatus 1 that the data frame that is the processing target goes through first, the setting of the PathID of the header is performed. Then, the data frame processing unit 33 issues an instruction to select the LD, to perform transmission of the received data frame.

Meanwhile, when a notification of the LD selected by the route selecting unit 35 is issued, the data frame processing unit 33 performs a transmitting process of the data frame. More specifically, when a notification of the LD selected by the route selecting unit 35 is issued, the data frame processing unit 33 sets the node ID of its node apparatus 1 itself to the LS of the header, and also sets the LD selected by the route selecting unit 35 to the LD of the header.

At this time, when the relay node apparatus 1 transmits the data frame to another relay node apparatus 1 and the value of the ACK flag is “0”, the data frame processing unit 33 sets the value of the ACK flag to “1”. Meanwhile, when the relay node apparatus 1 transmits the data frame to the end node apparatus 1 and the value of the ACK flag is “1”, the data frame processing unit 33 sets the value of the ACK flag to “1”. By doing so, the setting is made so that when the relay node apparatus 1 transmits the data frame to another relay node apparatus 1, the sending back of the ACK is not needed.

In addition, at this time, in preparation for the retransmission (retrying) of the data frame, the data frame processing unit 33 stores the data frame in the data area of the storing unit 20. By doing so, it becomes possible, when a need to retransmit the data frame arises, to duplicate the data frame for retransmission, on the basis of the data frame stored in the storing unit 20.

Then, the data frame processing unit 33 transmits the data frame to the adjacent node apparatus 1 that is the set LD, through the communication unit 10.

Meanwhile, when a notification of the failure of the transmission of the data frame is issued from the ACK processing unit 34, and furthermore, a notification of the LD selected by the route selecting unit 35 is issued, the data frame processing unit 33 performs the retransmission of the data frame. More specifically, the data frame processing unit 33 duplicates the corresponding data frame stored in the data area of the storing unit 20, and changes the LD of the duplicated data frame to the LD selected by the route selecting unit 35. Then, the data frame processing unit 33 transmits the duplicated data frame to the adjacent node apparatus 1 that is the LD after the change, through the communication unit 10. At this time, when the LD selected by the route selecting unit 35 is the LS, the data frame processing unit 33 deletes the corresponding data frame stored in the data area of the storing unit 20. In addition, as needed, the setting of the ACK flag is changed.

The data frame processing unit 33 further generates the data frame with the header illustrated in FIG. 3, and transmits the generated data frame to another node apparatus 1. However, the relay node apparatus 1 is a node apparatus exclusively for relaying, and therefore, does not perform the generating process of the data frame. That is, the relay node apparatus 1 itself does not behave as the GS.

The ACK processing unit 34 performs the process to transmit/receive the ACK. More specifically, the ACK processing unit 34 generates the ACK upon receiving a generation instruction for the ACK from the data frame processing unit, and sends back the generated ACK to the LS.

In addition, upon receiving the ACK within a prescribed time after transmitting a data frame, the ACK processing unit 34 determines that the transmission of the data frame has been successful, and deletes the corresponding data frame stored in the data area of the storing unit 20.

On the other hand, when the ACK is not received within a prescribed time, the ACK processing unit 34 determines that the transmission of the data frame has failed, and to the data frame processing unit 33 and the route selecting unit 35, issues a notification of the failure of the transmission of the data frame.

In addition, the ACK processing unit 34 notifies the link managing unit 32 of the result of the judgment as to whether or not the transmission of the data frame has been successful. By doing so, it becomes possible for the link managing unit 32 to change the priority of the routing table T2 on the basis of whether or not the transmission of the data frame has been successful.

The route selecting unit 35 selects, when it is necessary to transmit the received data frame to another node apparatus 1, the adjacent node apparatus 1 to be the transmission destination of the data frame, that is, the LD, referring to the routing table T2. Then, the route selecting unit 35 notifies the data frame processing unit 33 of the selected LD.

More specifically, when an instruction to select the LD is issued from the data frame processing unit 33, or when a notification of the failure of the transmission of the data frame is issued from the ACK processing unit 34, the route selecting unit 35 identifies the routing table T2 corresponding to the GD of the data frame that is the transmission target. Then, the route selecting unit 35 selects the adjacent node apparatus 1 that is the transmission destination, that is, the LD, on the basis of the priority of the identified routing table T2.

Meanwhile, when it is impossible to identify the routing table T2 corresponding to the GD of the data frame that is the transmission target, the route selecting unit 35 issues an instruction to generate the routing table T2 corresponding to the GD of the data frame that is the transmission target, to the link managing unit 32. Then, the route selecting unit 35 selects the adjacent node apparatus 1 that is the transmission destination, that is, the LD, on the basis of the priority of the routing table T2 generated by the link managing unit 32.

For example, when the data frame that is the transmission target is not loop data, that is, when the data frame is received for the first time, the route selecting unit 35 selects the LD candidate with the highest priority, from LD candidates excluding the adjacent node apparatus 1 (LS) of the transmission source.

Meanwhile, the data frame that is the transmission target is for example a loop data, or, when a notification of the failure of the transmission of the data frame is issued, the route selecting unit 35 selects the LD candidate with the highest priority, from LD candidates excluding the adjacent node apparatus 1 (LS) of the transmission source and the adjacent node apparatus 1 to which an attempt for transmission has already been made.

At this time, when it is impossible to identify the LD, the route selecting unit 35 selects the adjacent node apparatus 1 (LS) of the transmission source as the LD so as to send back the data frame to the adjacent node apparatus (LS) of the transmission source.

The hello frame generating unit 36 generates the hello frame at a prescribed timing (for example, regularly), and transmits the generated hello frame to another node apparatus 1 through the communication unit 10.

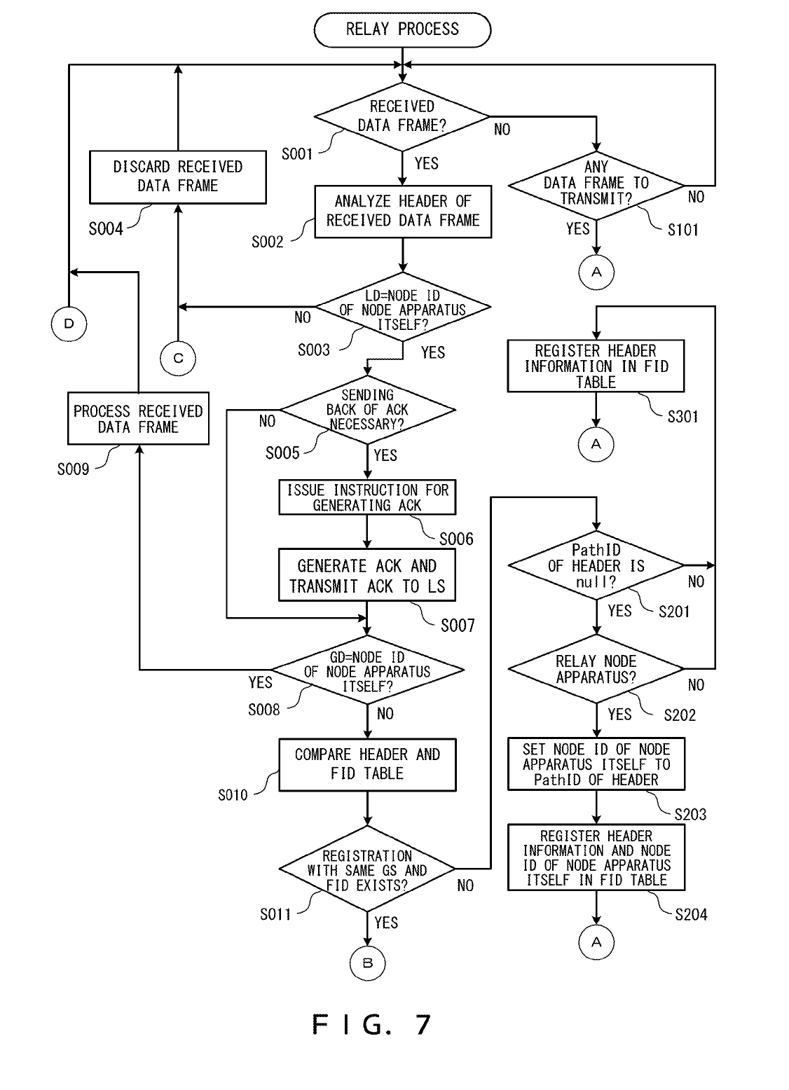

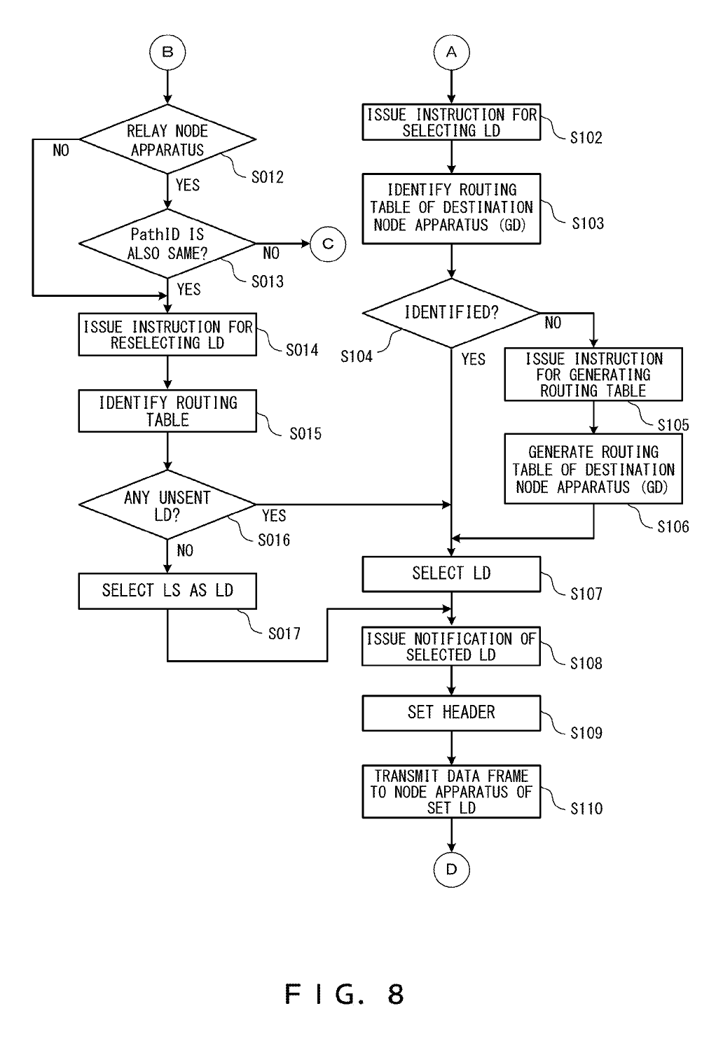

Next, referring to FIG. 7 and FIG. 8, the flow of the relay process in the present embodiment 1 is explained. FIG. 7 and FIG. 8 are a portion of an example of a flowchart for explaining the flow of the relay process in the present embodiment 1, and another portion of this flowchart, respectively. The relay process is started with the reception of a data frame as a trigger.

The data frame processing unit 33 judges whether or not a data frame has been received (step S001). When it is determined that no data frame has been received (step S001; NO), the data frame processing unit 33 further judges whether or not there is any data frame that its node apparatus 1 itself transmits as the GS (step S101). However, when the relay node apparatus 1 executes this relay process, as described above, the relay node apparatus 1 does not function as the GS, and therefore, the process of step S101 is not executed. For this reason, when a judgment of NO is made in the process of step S001, the process of step S001 is repeated so as to wait for the reception of the data frame.

When a judgment is made by the data frame processing unit 33 that there is not any data frame that its node apparatus 1 itself transmits as the GS (step S101; NO), the process returns to the process in step S001, and the process described above is repeated. Meanwhile, when a judgment is made by the data frame processing unit 33 that there is a data frame that its node apparatus 1 itself transmits as the GS (step S101; YES), the process proceeds to the process of step S102 described later.

On the other hand, in the process of step S001, when it is determined that a data frame has been received (step S001, YES), the data frame processing unit 33 analyzes the header of the received data frame (step S002), and judges whether the LD matches the node ID of its node apparatus itself (step S003).

When it is determined that the LD does not match the node ID of it node apparatus itself (step S003; NO), the data frame processing unit 33 discards the received data frame (step S004). Then, the process returns to the process of step S001 to wait for the reception of the next data frame.

On the other hand, when it is determined that the LD matches the node ID of the node apparatus itself (step S003; YES), the data frame processing unit 33 judges whether or not it is necessary to send back the ACK to the LS on the basis of the ACK flag of the received data frame (step S005).

When a judgment is made by the data frame processing unit 33 that it is not necessary to send back the ACK to the LS (step S005; NO), the process proceeds to the process of step S008 described later. On the other hand, when a judgment is made by the data frame processing unit 33 that it is necessary to send back the ACK to the LS (step S005; YES), the data frame processing unit 33 issues an instruction to generate the ACK to the ACK processing unit 34 (step S006).

The ACK processing unit 34 that has received the generation instruction for the ACK generates an ACK, and transmits the generated ACK to the adjacent node apparatus 1 (LS) of the transmission source, through the communication unit 10 (step S007). Then, the data frame processing unit 33 judges whether or not the GD matches the node ID of its node apparatus itself (step S008). That is, the data frame processing unit 33 judges whether or not the final destination of the received data frame is its node apparatus 1 itself.

When it is determined that the GD matches its node ID of the node apparatus itself (step S008; YES), the data frame processing unit 33 outputs the received data frame to the upper-level layer, and in response to the input of the data frame, the upper-level layer performs processing of the received data frame (step S009).

On the other hand, when it is determined that the GD does not match the node ID of its node apparatus 1 itself (step S008; NO), the data frame processing unit 33 compares the header and the FID table T1 (step S010), and judges whether or not there is a registration in the FID table T1 whose combination of the GD and FID matches the combination of the GD and FID of the header (step S011).

When it is determined that there is a registration in the FID table T1 whose combination of the GD and FID matches the combination of the GD and FID of the header (step S011; YES), the data frame processing unit 33 further judges whether or not its node apparatus 1 itself is the relay node apparatus 1 on the basis of the information indicating the type of its node apparatus 1 itself stored in the data area of the storing unit (step S012).

When a judgment is made by the data frame processing unit 33 that that its node apparatus 1 is not the relay node apparatus 1 (step S012; NO), the process proceeds to the process in step S014. This is because, in the present embodiment 1, the configuration is made so that the distinguishing between loop data and overlapped data is executed only in the relay node apparatus 1.

On the other hand, when a judgment is made by the data frame processing unit 33 that that its node apparatus 1 is the relay node apparatus 1 (step S012; YES), the data frame processing unit 33 further judges whether or not the PathID of the header matches the PathID of the registration whose combination of the GD and the FID matches the combination of the GD and FID of the header (step S013). That is, the data frame processing unit 33 judges whether or not there is a registration in the FID table T1 that matches the combination of the GD and FID and the PathID of the header.

When it is determined that the PathID does not match (step S013; NO), that is, when it is determined that the received data frame is overlapped data, the data frame processing unit 33 discards the received data frame (step S004).

On the other hand, when it is determined that the PathID also matches (step S013; YES), that is, when it is determined that the received data frame is loop data, the data frame processing unit 33 issues an instruction to re-select the LD to the route selecting unit 35 (step S104).

The route selecting unit 35 that has received the instruction re-select the LD identifies the routing table T2 corresponding to the GD of the data frame that is the transmission target (step S015), and judges whether or not there is any “LD candidate” to which the data frame that is the transmission target has not been transmitted (step S016).

When it is determined by the route selecting unit 35 that there is still an “LD candidate” to which the data frame that is the transmission target has not been transmitted (step S016; YES), the process proceeds to the process in step S107. On the other hand, when it is determined there is no more “LD candidate” to which the data frame that is the transmission target has not been transmitted (step S016; NO), the route selecting unit 35 selects the LS as the LD (step S017), and the process proceeds to the process in step S108 described later. That is, a process to send back the received data frame to the node apparatus 1 that is the transmission source is performed.

In the process in step S011, when it is determined that there are no registrations in the FID table T1 whose combination of the GD and FID match the combination of the GD and FID of the header (step S011; NO), that is, when it is determined that the data frame is received for the first time, the data frame processing unit 33 executes a registration process in the FID table T1.

Specifically, the data frame processing unit 33 judges whether or not the PathID of the header is null (step S201). When it is determined that the PathID of the header is not null (step S201; NO), that is, when the received data frame has already gone through a relay node apparatus 1, the data frame processing unit 33 associates and registers the GD and FID and the PathID of the header in the FID table T1 (step S301). Then, the process proceeds to the process of step S102 described later.

On the other hand, when it is determined that the PathID of the header is null (step S201; YES), that is, when the received data frame is a data frame that has not gone through a relay node apparatus 1, the data frame processing unit 33 further judges whether or not its node apparatus 1 itself is the relay node apparatus 1, on the basis of the information indicating the type of its node apparatus 1 itself stored in the data area of the storing unit 20 (step S202).

When it is determined that its node apparatus 1 itself is the end node apparatus 1 (step S202; NO), the process proceeds to the process of step S301, and the process described above is performed.

On the other hand, when it is determined that its node apparatus 1 itself is the relay node apparatus 1 (step S202; YES), the data frame processing unit 33 sets the node ID of its node apparatus itself to the PathID of the header (step S203), and associates and registers the node ID of its node apparatus itself and the GD and the FID of the header in the FID table T1 (step S204). That is, in the relay node apparatus 1 that the data frame that is the processing target goes through first, the setting of the PathID of the header is performed. Then, the process proceeds to the process of S102 described later.

In the process in step S102, the data frame processing unit 33 issues an instruction to select the LD to the route selecting unit 35 (step S102).

The route selecting unit 35 that has received the selection instruction of the LD identifies the routing table T2 corresponding to the GD of the data frame that is the transmission target (step S103), and judges whether or not the routing table T2 has been identified (step S104). When it is determined that the routing table T2 has not been identified (step S104; NO), the route selecting unit 35 issues an instruction to generate the routing table T2 corresponding to the GD of the data frame that is the transmission target to the link managing unit 32 (step S105).

The link managing unit 32 that has received the generation instruction of the routing table T2 generates the routing table T2 corresponding to the GD for which the generation has been instructed (step S106).

Then, the route selecting unit 35 selects the adjacent node apparatus 1 that is the transmission destination, that is, the LD, on the basis of the priority of the routing table T2 identified in the process of the step S015 or the step S103, or generated in the process of step S106 (step S107).

Then, the route selecting unit 35 notifies the data frame processing unit 33 of the selected LD (step S108). The data frame processing unit 33 that has received the notification of the selected LD performs the setting of the header (step S109).

Then, the data frame processing unit 33 transmits the data frame to the set LD, that is, the adjacent node apparatus 1 that is the LD selected by the route selecting unit 35, through the communication unit 10 (step S110). Then, the process returns to the process of step S001, to wait for the next reception of the data frame.

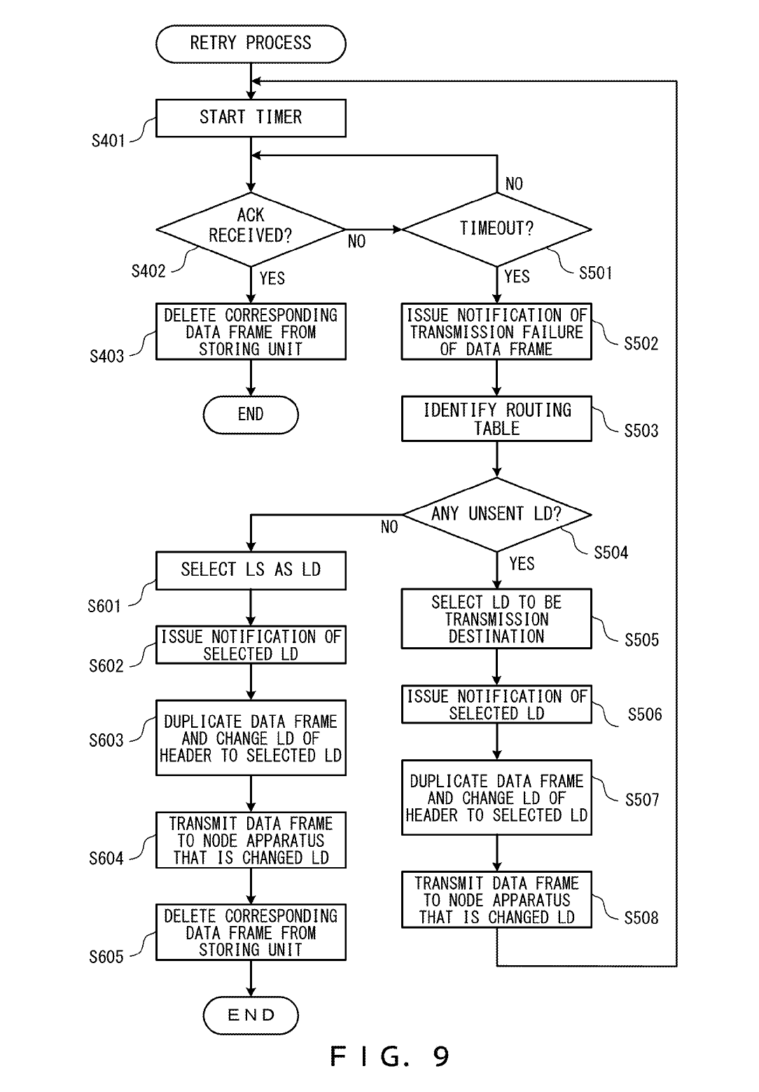

Next, referring to FIG. 9, the flow of the retry process in the present embodiment 1 is explained. FIG. 9 is an example of a flowchart for explaining the flow of the retry process in the present embodiment 1. The retry process is started with the transmission of a data frame in the relay process as a trigger.

Meanwhile, this retry process is not executed when the relay node apparatus 1 relays the data frame to another relay node apparatus 1. This is because, in the present embodiment 1, the configuration is made so that when the relay node apparatus 1 relays the data frame to another relay node apparatus 1, the ACK is not sent back.

When a data frame is transmitted by the data frame processing unit 33, the ACK processing unit 34 starts a timer (not illustrated in the drawing) (step S401), and judges whether or not an ACK sent back from the adjacent node apparatus 1 (LD) that is the transmission destination of the data frame has been received (step S402).

When it is determined that the ACK has been received (step S402; YES), the ACK processing unit 34 deletes the corresponding data frame stored in the data area of the storing unit 20 (step S403), and since the transmission of the data frame has been successful, the retry process is terminated.

On the other hand, when it is determined that the ACK has not been received yet (step S402; NO), the ACK processing unit 34 further judges whether or not a timeout has occurred (step S501). When it is determined that the timeout has not occurred yet (step S501; NO), the process returns to the process of step S402, to repeat the process described above.

On the other hand, when it is determined that the timeout has occurred (step S501; YES), the ACK processing unit i34 determines that the transmission of the data frame has failed, and to the data frame processing unit 33 and the route selecting unit 35, issues a notification that the transmission of the data frame has failed (step S502). At this time, the ACK processing unit 34 notifies the link managing unit 32 of the judgment as to whether the transmission of the data frame has been successful. By doing so, it becomes possible for the link managing unit 32 to change the priority of the routing table T2 on the basis of whether or not the transmission of the data frame has been successful.

The route selecting unit 35 that has received the notification of the transmission failure of the data frame identifies the routing table T2 corresponding to the GD of the data frame that is the transmission target (step S503), and judges whether or not there is any “LD candidate” to which the data frame that is the transmission target has not been transmitted (step S504).

When it is determined that there is still a “LD candidate” to which the data frame that is the transmission target (step S504; YES), the route selecting unit 35 selects the LD (step S505), and notifies the data frame processing unit 33 of the selected LD (step S506).

When a notification of the failure of the transmission of the data frame is issued from ACK processing unit 34, and further, a notification of the selected LD is issued from the route selecting unit 35, the data frame processing unit 33 duplicates the corresponding data frame stored in the data area of the storing unit 20, and changes the LD of the duplicated data frame to the LD selected by the route selecting unit 35 (step S507).

Then, the data frame processing unit 33 transmits the duplicated data frame to the adjacent node apparatus 1 that is the LD after the change, through the communication unit 10 (step S508), the process returns to the process in step S401, and the process described above is repeated.

In the process in step S504, when it is determined that there is no more “LD candidate” to which the data frame that is the transmission target has not been transmitted (step S504; NO), the route selecting unit 35 selects the LS as the LD (step S601), notifies the data frame processing unit 33 of the selected LD (step S602).

When a notification of the failure of the transmission of the data frame is issued from ACK processing unit 34, and further, a notification of the selected LD is issued from the route selecting unit 35, the data frame processing unit 33 duplicates the corresponding data frame stored in the data area of the storing unit 20, and changes the LD of the duplicated data frame to the LD selected by the route selecting unit 35 (step S603).

Then, the data frame processing unit 33 transmits the duplicated data frame to the adjacent node apparatus 1 that is the LD after the change, through the communication unit 10 (step S604), and deletes the corresponding data frame stored in the data area of the storing unit 20 (step S605). As described above, the data frame is sent back to the adjacent node apparatus 1 (LS) that is the transmission source, and the process is terminated.

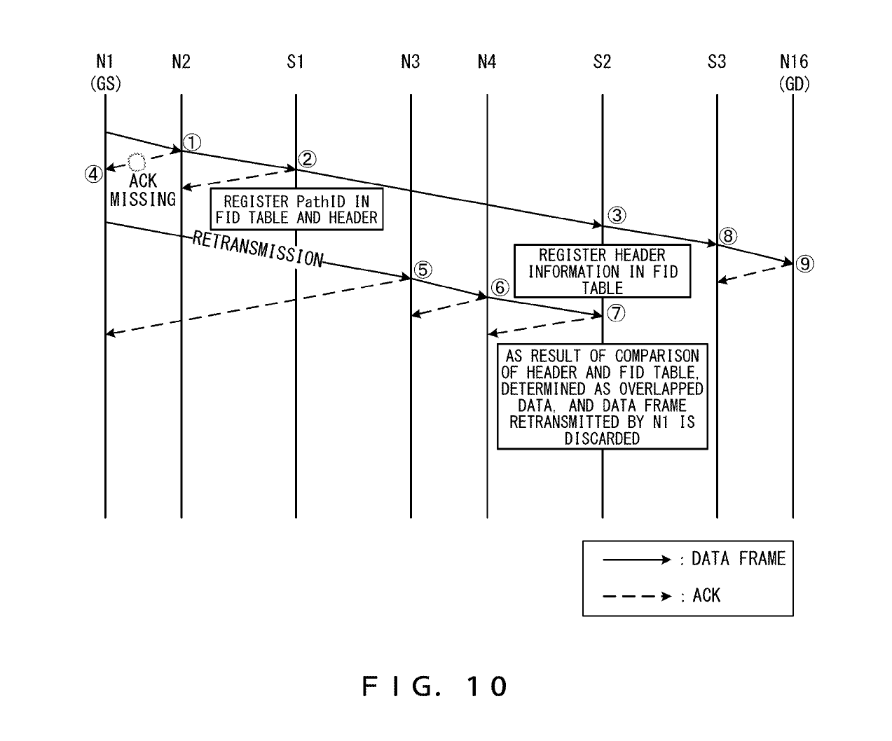

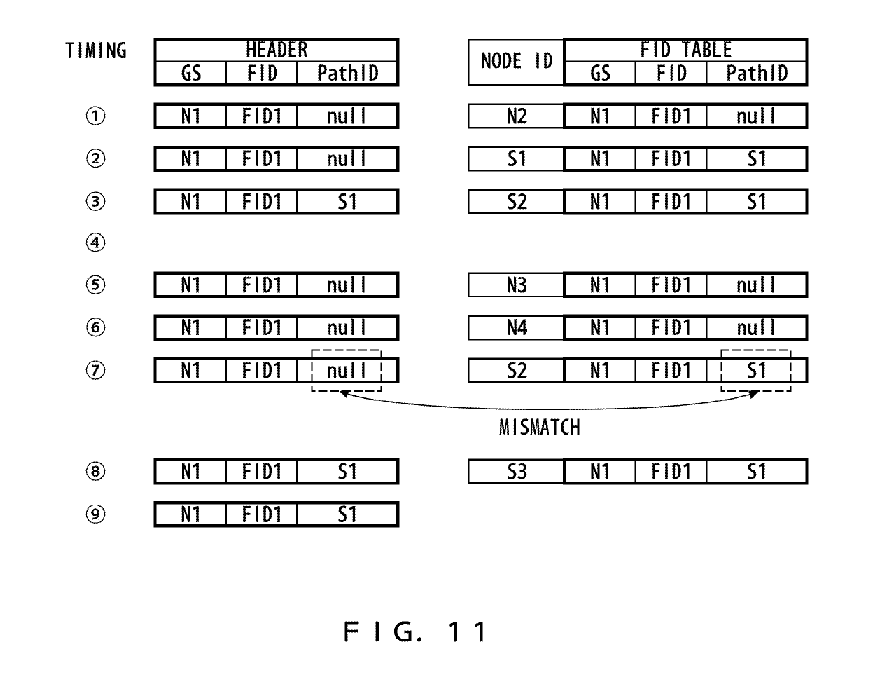

Next, referring to FIG. 1 and FIG. 6 through FIG. 11, the flow of the relay process in the present embodiment 1 is explained according to the specific example. FIG. 10 is a timing chart corresponding to the example illustrated in FIG. 1. However, the circled numbers in the drawing are not necessarily the numbers assigned chronologically, but are the numbers assigned to identify the respective numbers. In addition, these numbers are supposed to be associated in FIG. 1 and FIG. 10 and FIG. 11. FIG. 11 is a diagram illustrating the contents of the header and the FID table at the respective timings of the timing chart in FIG. 10.

Meanwhile, while a plurality of different data frames may be transmitted at the same time through the network 100, here, the explanation is given focusing on the flow of the relay of one data frame. In this specific example, referring to FIG. 1 and FIG. 10, it is assumed that the data frame transmitted from the relay node apparatus S1 reaches the relay node apparatus S2 earlier than the data frame transmitted from the end node apparatus N4.

Referring to FIG. 1, FIG. 6, and FIG. 10, at the timing 1, the end node apparatus N1 generates, as the GS, a data frame with the end node apparatus N16 as the GD (the FID is FID 1), and since the priority p1> priority p2, it transmits the generated data frame to the end node apparatus N2. The GS and the FID and the PathID of the data frame at the timing 1 are N1, FID 1, and null, respectively, as illustrated in FIG. 11.

Referring to FIG. 7, since there are no registrations in the FID table T1 whose combination of the GS and the FID match (step S011; NO) and since the PathID of the header is null (step S201; YES) and the node apparatus N2 is the end node apparatus 1 (step S202; NO), the end node apparatus N2 that has received the data frame associates the GS (N1) and the FID (FID 1) and the PathID (null) of the received data frame and registers them in the FID table T1 as illustrated in FIG. 11 (step S301).

Referring to FIG. 1 and FIG. 10, at the timing 1, the end node apparatus N2 transmits the data frame to the relay node apparatus S1. The GS and the FID and the PathID of the data frame at the timing 1 are, as it has not gone through any relay node apparatus 1, still N1, FID 1, and null, respectively, as illustrated in FIG. 11.

Referring to FIG. 7, since there are no registrations in the FID table T1 whose combination of the GS and the FID match (step S011; NO), and since the PathID of the header is null (step S201; YES) and the relay node apparatus S1 is not the relay node apparatus 1 (step; YES), the relay node apparatus S1 that has received the data frame sets S1 that is the node ID of itself to the PathID of the header (step S203). Then, the GS (N1) and FID (FID 1) and PathID (S1) of the received data frame are associated, and registered in the FID table T1 as illustrated in FIG. 11 (step 204).

Referring to FIG. 1 and FIG. 10, at the timing 3, the relay node apparatus S1 transmits the data frame to the relay node apparatus S2. The GS and FID and PathID of the data frame at the timing 3 are N1, FID 1, and S1, respectively, since the data frame has gone through the relay node apparatus S1, as illustrated in FIG. 11.

Referring to FIG. 7, since there are no registrations in the FID table T1 whose combination of the GS and the FID match (step S011; NO) and the PathID of the header is S1 (step S201; NO), the relay node apparatus S2 associates the GS (N1) and FID (FID 1) and PathID (S1) of the received data frame, and registers them in the FID table T1 as illustrated in FIG. 11 (step S301).

Referring to FIG. 1 and FIG. 10, at the timing 4, it is assumed that, for example, due to a communication failure, the ACK sent back from the end node apparatus N2 to the end node apparatus N1 is missing.

Referring to FIG. 1 and FIG. 10, at the timing 5, since the ACK is not received, the end node apparatus N1 determines that the transmission to the end node apparatus N2 has failed (step S501 of the retry process in FIG. 9; YES), and a retransmission (retry) of the data frame is performed to the end node apparatus N3. In order to distinguish between the original data frame and the retransmitted data frame, the re-transmitted data frame is referred to as the retransmitted data frame. The GS and FID and PathID of the retransmitted data frame at the timing 5 are N1, FID 1, and null, respectively, as illustrated in FIG. 11.

Referring to FIG. 7, since there are no registrations in the FID table T1 whose combination of the GS and the FID match (step S011; NO), the PathID of the header is null (step S201; YES), and the node apparatus N3 is the end node apparatus 1 (step S202; NO), the end node apparatus N3 that has received the retransmitted data frame associates the GS (N1) and FID (FID 1) and PathID (null) of the received retransmitted data frame, and registers them in the FID table T1, as illustrated in FIG. 11 (step S301).

Referring to FIG. 1 and FIG. 10, at the timing 6, the end node apparatus N3 transmits the retransmitted data frame to the end node apparatus N4. The GS and FID and PathID of the retransmitted data frame are, since it has not gone through any relay node apparatuses 1, still N1, FID 1, and null, respectively, as illustrated in FIG. 11.

Referring to FIG. 7, since there are no registrations in the FID table T1 whose combination of the GS and the FID match (step S011; NO), the PathID of the header is null (step S201; YES), and the node apparatus N4 is the end node apparatus 1 (step S202; NO), the end node apparatus N4 that has received the retransmitted data frame associates the GS (N1) and FID (FID 1) and PathID (null) of the received retransmitted data frame and registers them in the FID table T1, as illustrated in FIG. 11 (step S301).

Referring to FIG. 1 and FIG. 10, at the timing 7, the end node apparatus N4 retransmits the retransmitted data frame to the relay node apparatus S2. The GS and FID and PathID of the retransmitted data frame at the timing 7 are, since it has gone through no relay node apparatus 1, still N1, FID 1, and null, respectively, as illustrated in FIG. 11.

Referring to FIG. 7, FIG. 8 and FIG. 11, since there is a registration whose combination of the GS and FID already matches in the FID table T1 (step S011; YES), the node apparatus S2 is the relay node apparatus 1 (step S012; YES), and the PathID (null) of the header and the PathID (S1) of the FID table T1 do not match (step S013; NO), the relay node apparatus S2 that has received the retransmitted data frame determines that the received retransmitted data frame is overlapped data. Then, the relay node apparatus S2 discards the received retransmitted data frame (step S004). It becomes possible to suppress the increase in the traffic in the entire network in the way described above.

Referring to FIG. 1 and FIG. 10, at the timing 8, the relay node apparatus S2 transmits the data frame to the relay node apparatus S3. The FID and PathID of the data frame at the timing 8 are N1, FID 1, and S1, respectively, since it is the original data frame that has gone through the relay node apparatus S1, as illustrated in FIG. 11.

Referring to FIG. 7, since there are no registrations in the FID table T1 whose combination of the GS and the FID match (step S011; NO) and the PathID of the header is S1 (step S201; NO), the relay node apparatus S3 that has received the data frame associates the GS (N1), FID (FID 1), and PathID (S1) of the received data frame, and registers them in the FID table T1 as illustrated in FIG. 11 (step S301).

Referring to FIG. 1 and FIG. 10, at the timing 9, the relay node apparatus S3 transmits the data frame to the end node apparatus N16 that is the GD. The GS, FID, and PathID of the data frame at the timing 9 are N1, FID 1, S1, respectively, since it is the original data frame that has gone through the relay node apparatus S1, as illustrated in FIG. 11.

Referring to FIG. 7, the end node apparatus N16 that has received the data frame analyzes the header (step S002), and since the GD is the node ID of the node apparatus itself (step S008; YES), outputs the received data frame to the upper-level layer. The upper-level layer processes the received data frame (step S009), and the relay process is terminated.

According to embodiment 1 described above, upon receiving a data frame, the relay node apparatus 1 judges whether or not there is a registration in the FID table T1 whose combination of the GS and FID matches, and when there is a registration that matches, on the basis of the PathID, judges whether the received data frame is loop data or overlapped data.

By making the configuration as described above, it becomes possible to distinguish between overlapped data and loop data. Accordingly, it becomes possible to prevent a wrong path change due to a wrong judgment of overlapped data as loop data. Therefore, it becomes possible to prevent the disconnection of the network and the isolation of a node apparatus due to a wrong path change, making it possible to maintain an appropriate path.

In addition, according to embodiment 1 above, the relay node apparatus 1 discards the received data frame without transmitting it to another node apparatus 1, when the received data frame is overlapped data. By making the configuration as described above, it becomes possible to suppress the increase in the traffic in the entire network.

Embodiment 2 is explained.

In embodiment 1, a method to distinguish between loop data and overlapped data on the basis of the “GS”, “FID”, and “PathID” is explained. In the present embodiment 2, a method to distinguish between loop data and overlapped data on the basis of the “GS”, “FID”, “retry ID” and “number of retries” is explained.

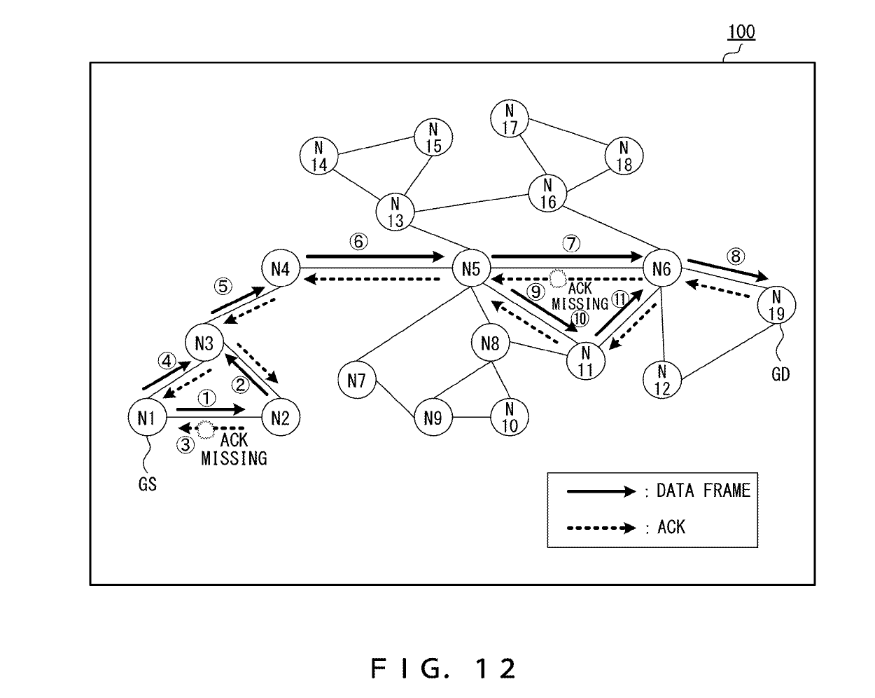

FIG. 12 is a conceptual diagram of the network 100 in the present embodiment 2. The network 100 in the present embodiment 2 is constituted by, as illustrated in FIG. 12, for example, the end node apparatus 1 only. As the network 100 like this, for example, a network in an area with a concentration of houses is expected. Naturally, in the network 100 in which the end node apparatus 1 and the relay node apparatus 1 exist in a mixed manner, it is possible to apply the method to distinguish between loop data and overlapped data explained in the present embodiment 2.

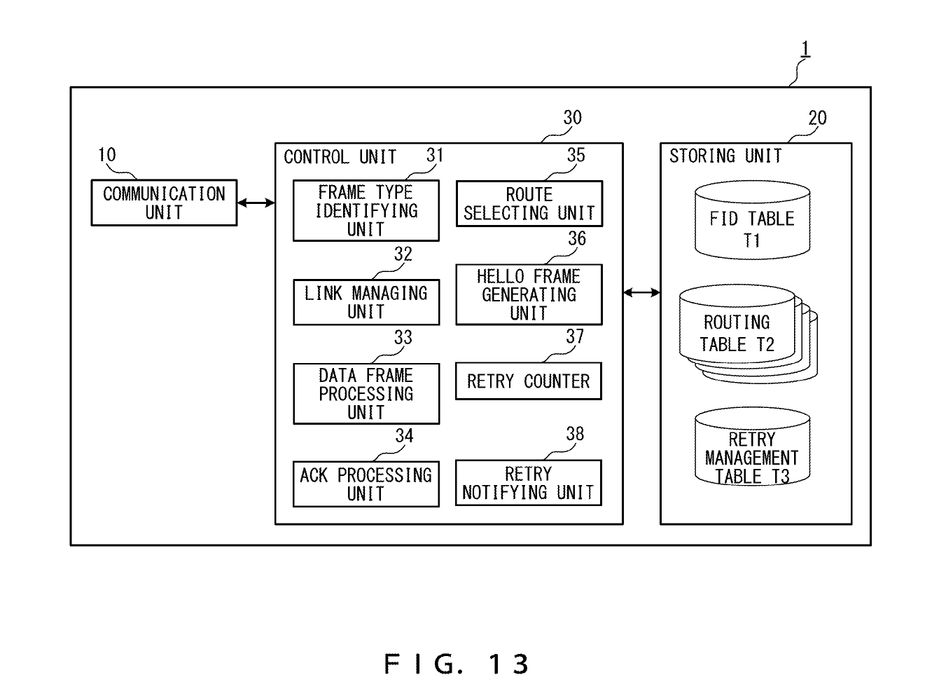

FIG. 13 is a functional block diagram illustrating a configuration example of the node apparatus 1 that constitutes the network 100 in the present embodiment 2. The configuration of the node apparatus 1 in the present embodiment 2 is essentially the same as the case of embodiment 1. However, as illustrated in FIG. 13, it differs from the case of embodiment 1 in that the storing unit 20 further stores a retry management table T3, and that the control unit 30 further functions as a retry counter 37 and a retry notifying unit 38. In addition, the role played by a part (the data frame processing unit 33, the ACK processing unit 34) of the common functional units of the control unit 30 is slightly different from the case of embodiment 1. In addition, the format of the header and the configuration of the FID table T1 are also different from the case of embodiment 1.

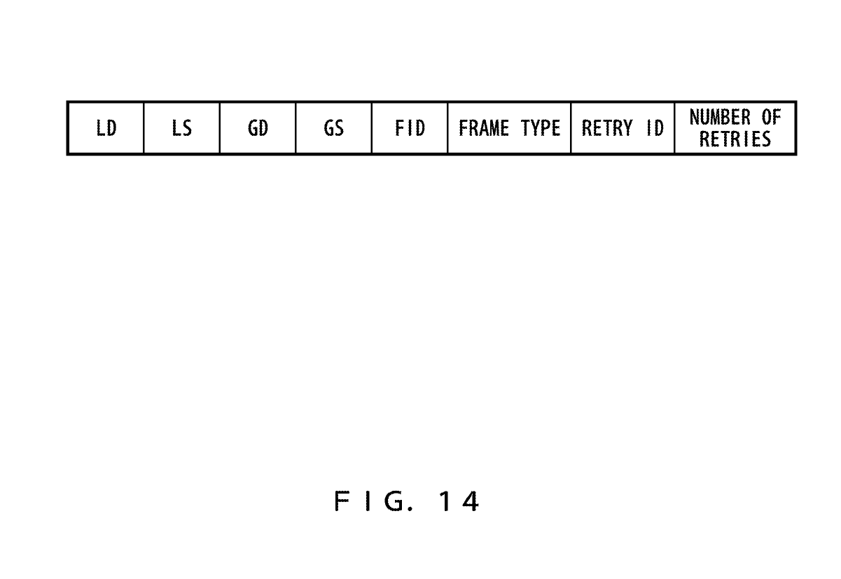

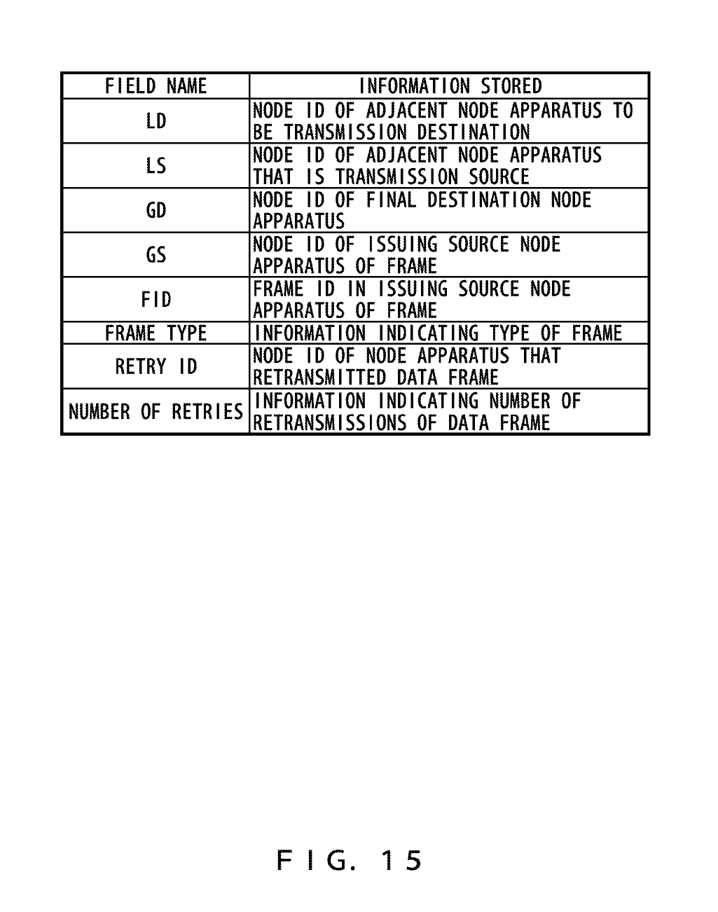

First, referring to FIG. 14 and FIG. 15, the header in the present embodiment 2 is explained. FIG. 14 is a diagram illustrating a format example of the header of the data frame in the present embodiment 2. FIG. 15 is the explanation of each field in the format example in FIG. 14.

The header of the data frame in the embodiment 2 includes, as illustrated in FIG. 14, the LD, LS, GD, GS, FID, frame type, retry ID, and number of retries. The LD, LS, GD, GS, FID and the frame type are the same as those explained in embodiment 1.

The retry ID is the node ID of the node apparatus 1 that performs the retransmission (retry) of the data frame. The number of retries is the number of the retransmissions (retries) (the counter value of the retry counter 37) of the data frame performed by the node apparatus 1 identified by the retry ID.

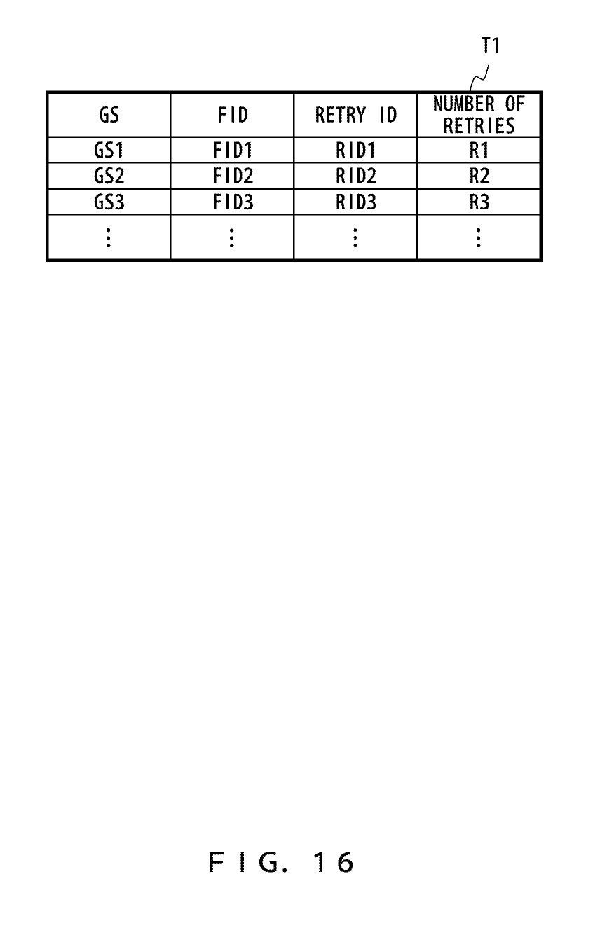

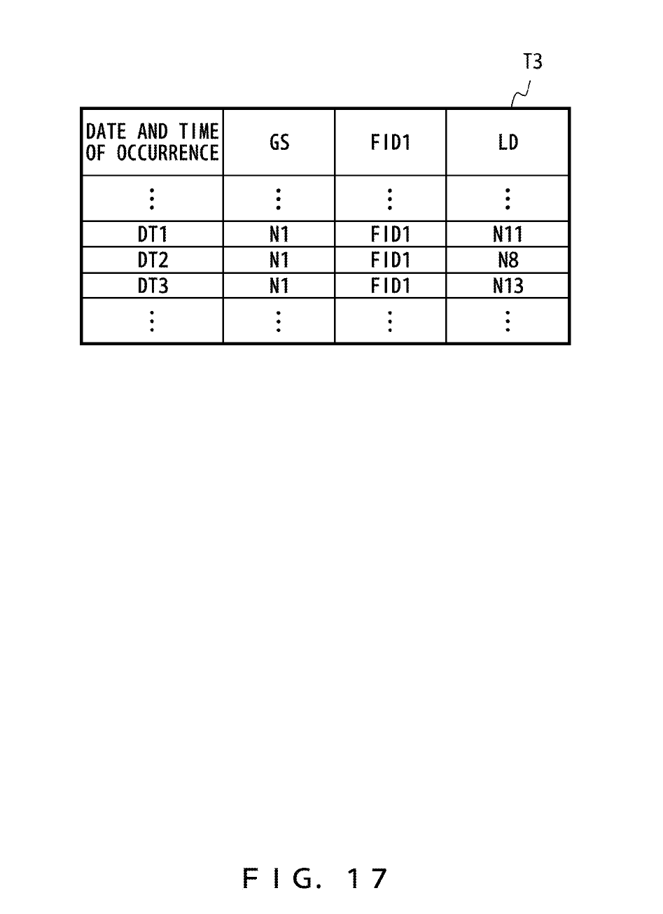

Next, referring to FIG. 16 and FIG. 17, the FID table T1 and the retry management table T3 stored in the data area of the storing unit 20 are explained. Meanwhile, the routing table T2 in the present embodiment 2 is the same as in the case of embodiment 1.

FIG. 16 is a diagram illustrating an example of the FID table T1 in the present embodiment 2. The FID table T1 in the present embodiment 2 is managed by the data frame processing unit 33, and is a table in which the “GS”, “FID”, “retry ID”, and “number of retries” are associated. In the same manner as in the case of embodiment 1, the data frame processing unit 33 performs a registration process in the FID table T1 when there are no registrations in the FID table T1 whose combination of the GD and FID match.

FIG. 17 is a diagram illustrating an example of the retry management table T3 in the present embodiment 2. Meanwhile, the retry management table T3 illustrated in FIG. 17 is an example of the retry management table T3 provided in the end node apparatus N5.

The retry management table T3 is generated and managed by the data frame processing unit 33, and is a table that is referred to when the retry notifying unit 38 generates retry information (frame). In addition, the retry management table T3 is a table in which, as illustrated in FIG. 17, the “date/time of occurrence”, “GS”, “FID”, and “LD” are associated.

In the “date/time of occurrence” field, information indicating the date and time at which the retransmission (retry) of the data frame is performed is stored. In the “GS” field, the GS of the data frame that has become the retry target is stored. In the “FID” field, the FID of the data frame that has become the retry target is stored. In the “LD” field, the LD selected at the time of the retry is stored.

For example, referring to FIG. 17 (which is an example of the retry management table T3 provided in the end node apparatus N5), it is understood that the first retry of the data frame of the FID 1 issued in the end node apparatus N1 (GS) is performed on the date/time DT T1 in the end node apparatus N5 to the end node apparatus N11 (LD).

Returning to FIG. 13, the data frame processing unit 33 performs processing of the received data frame. More specifically, the data frame processing unit 33 first judges whether or not a data frame has been received by judging whether or not a data frame has been input by the frame type identifying unit 31. Then, upon receiving a data frame, the data frame processing unit 33 analyzes the header of the received data frame and judges whether or not the LD matches the node ID of the node apparatus itself.

Then, when the LD does not match the node ID of the node apparatus itself, the data frame processing unit 33 discards the received data frame, and when the LD matches the node ID of the node apparatus itself, issues an instruction to generate an ACK to the ACK processing unit 34. Then, the data frame processing unit 33 judges whether or not the GD matches the node ID of its node apparatus itself. That is, the data frame processing unit 33 judges whether or not the final destination of the received frame is its node apparatus 1 itself.

When the final destination of the received data frame is its node apparatus 1 itself, the data frame processing unit 33 outputs the received data frame to the upper-level layer. In response to the input of the data frame, the upper-level layer performs processing of the received data frame.

On the other hand, when the final destination of the received data frame is another node apparatus 1, the data frame processing unit 33 compares the header and the FID table T1, and judges whether or not there is a registration in the FID table T1 whose combination of the GD and FID matches the combination of the GD and FID of the header. That is, the data frame processing unit 33 judges whether or not the same data frame has already been received.

When there is a registration in the FID table T1 whose combination of the GD and FID matches the GD and the FID of the header, the data frame processing unit 33 further judges whether or not the retry ID of the header and the node ID of its node apparatus itself match. That is, the data frame processing unit 33 judges whether or not the received data frame is a data frame that its node apparatus 1 itself has retransmitted.

When it is not a data frame that its node apparatus 1 itself has retransmitted, the data frame processing unit 33 further judges whether or not the combination of the retry ID and the number of retries of the header matches the combination of the retry ID and the number of retries of a registration whose combination of the GD and FID matches the combination of the GD and FID of the header. That is, whether or not there is a registration in the FID table T1 that matches the combination of the GD and FID and retry ID and number of retries of the header is judged.

When there is a registration in the FID table T1 that matches the combination of the GD and FID and retry ID and number of retries of the header, or, when the received data frame is a data frame that its node apparatus 1 itself has retransmitted, the data frame processing unit 33 determines that the received data frame is loop data.

On the other hand, when there is a registration in FID table T1 that matches the combination of the GD and FID of the header but at least one of the retry ID and the number of retries does not match, the data frame processing unit 33 determines that the received data frame is overlapped data. As described above, in the present embodiment 2, it is possible to distinguish between loop data and overlapped data.

Then, upon determining that a received data frame is overlapped data, the data frame processing unit 33 discards the received data, and when it is determined as loop data, issues an instruction to re-select the LD to the route selecting unit 35. At this time, the data frame processing unit 33 notifies the link managing unit 32 that the loop has been made and of the LD at the time of the transmission of the loop data. By doing so, it becomes possible for the link managing unit 32 to change the priority of the routing table T2 appropriately.

Meanwhile, when there are no registrations in the FID table T1 whose combination of the GD and FID match the combination of the GD and FID of the header, that is, when the data frame is received for the first time, the data frame processing unit 33 performs a registration process in the FID table T1.

More specifically, the data frame processing unit 33 associates the GD and FID and retry ID and number of retries of the header and registers them in the FID table T1. Then, the data frame processing unit 33 issues an instruction to the route selecting unit 35 to select the LD so as to perform the transmission of the received data frame.

Meanwhile, when a notification of the LD selected by the route selecting unit 35 is issued, the data frame processing unit 33 performs a transmitting process of the data frame. More specifically, when a notification of the LD selected by the route selecting unit 35 is issued, the data frame processing unit 33 sets the node ID of its node apparatus 1 itself to the LS of the header, and also sets the LD selected by the route selecting unit 35 to the LD of the header.

At this time, in preparation for the retransmission (retry) of the data frame, the data frame processing unit 33 stores the data frame in the data area of the storing unit 20. By doing so, it becomes possible, when a need to retransmit the data frame arises, to duplicate the data frame for retransmission on the basis of the data frame stored in the storing unit 20.

Then, the data frame processing unit 33 transmits the data frame to the adjacent node apparatus 1 that is the set LD through the communication unit 10.

Meanwhile, when a notification of the failure of the transmission of the data frame is issued from the ACK processing unit 34, and furthermore, a notification of the LD selected by the route selecting unit 35 is issued, the data frame processing unit 33 performs the retransmission of the data frame. More specifically, the data frame processing unit 33 duplicates the corresponding data frame stored in the data area of the storing unit 20, and changes the LD of the duplicated data frame to the LD selected by the route selecting unit 35. Then, the data frame processing unit 33 transmits the duplicated data frame to the adjacent node apparatus 1 that is the LD after the change through the communication unit 10.

At this time, when the LD selected by the route selecting unit 35 is the LS, the data frame processing unit 33 deletes the corresponding data frame stored in the data area of the storing unit 20. When the LD selected by the route selecting unit 35 is not the LS, that is, when performing the retransmission (retry) of the data frame, the node ID of its node apparatus itself is set to the retry ID of the header, and as the number of retries, the counter value of the retry counter 37 is set.

Furthermore, the data frame processing unit 33 generates the data frame of the header illustrated in FIG. 14 in response to a request from the upper-level layer, and transmits the generated data frame to another node apparatus 1 through the communication unit 10.

In addition, in the present embodiment 2, the data frame processing unit 33 performs generation and management of the retry management table T3. More specifically, when the retry process occurs, the data frame processing unit 33 associates information indicating the date and time of occurrence of the retry, the GS and FID of the data frame that is the retry target, and the LD about which notification was made by the route selecting unit 35, and registers them in the retry management table T3.

The ACK processing unit 34 performs a process to transmit/retransmit the ACK. More specifically, the ACK processing unit 34 generates an ACK upon receiving a generation instruction for the ACK from the data frame processing unit, and sends back the generated ACK to the LS.

In addition, upon receiving the ACK within a prescribed time after transmitting a data frame, the ACK processing unit 34 determines that the transmission of the data frame has been successful, and deletes the corresponding data frame stored in the data area of the storing unit 20.

On the other hand, when the ACK is not received within a prescribed time, the ACK processing unit 34 determines that the transmission of the data frame has failed, and notifies the data frame processing unit 33 and the route selecting unit 35 of the failure of the transmission of the data frame.

In addition, the ACK processing unit 34 notifies the link managing unit 32 of the result of the judgment as to whether or not the transmission of the data frame has been successful. By doing so, it becomes possible for the link managing unit 32 to change the priority of the routing table T2 on the basis of whether or not the transmission of the data frame has been successful.

Furthermore, the ACK processing unit 34 controls the retry counter 37. Specifically, when the retry process is started, the retry counter 37 is initialized, and when the ACK is not received within a prescribed time, the retry counter 37 is incremented.

The retry counter 37 is a counter for managing the number of retransmissions (retry) of the data frame, and as described above, is controlled by the ACK processing unit 34. Meanwhile, the initial value of the counter value is “0”.

The retry notifying unit 38 refers to the retry management table T3 and generates retry information (frame) at a prescribed timing, and via the communication unit 10, for example transmits the generated retry information to a management server (not illustrated in the drawing). The retry information includes information registered in the retry management table T3 (for example, information indicating the data and time of occurrence and the LD) and the node ID of the node apparatus itself. As the prescribed timing, for example regularly, when requested from the management server, and the like may be expected.

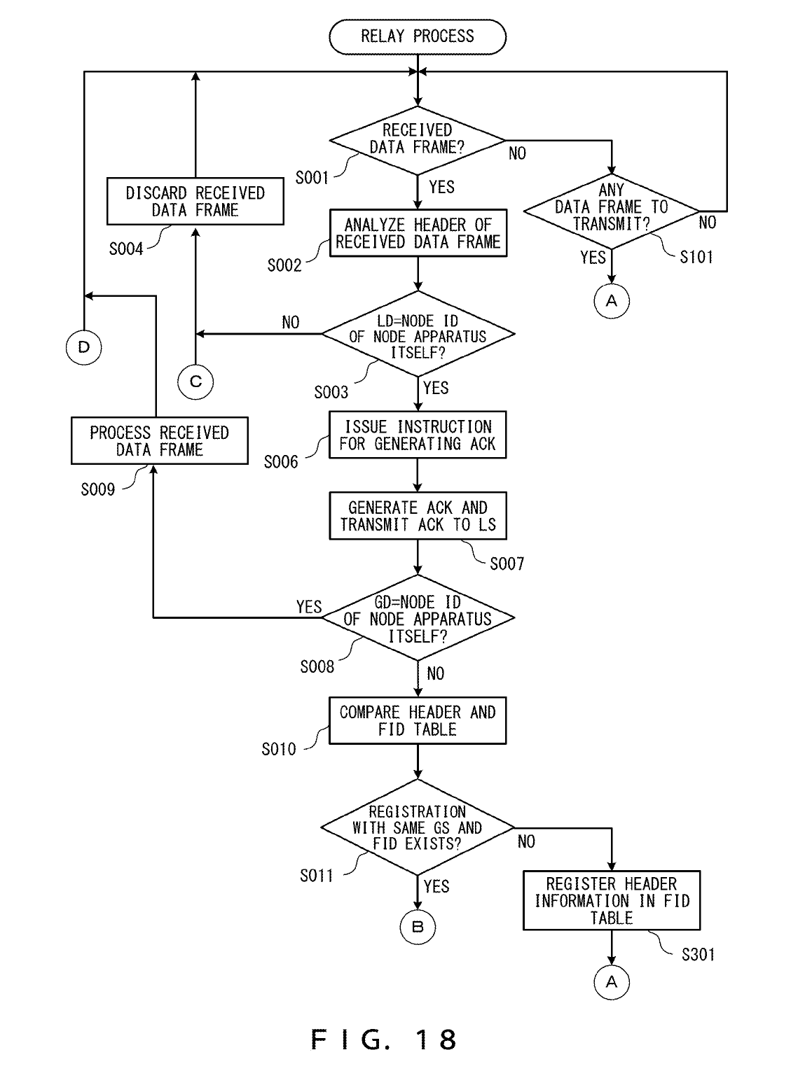

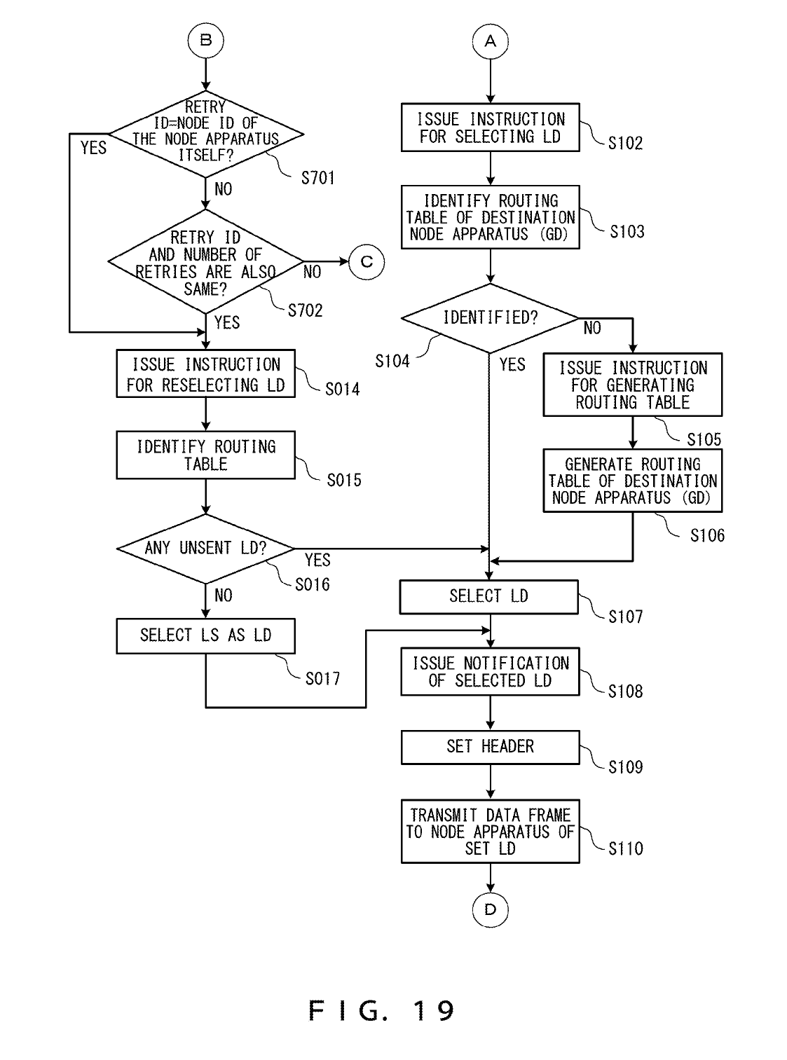

Next, referring to FIG. 18 and FIG. 19, the flow of the relay process in the present embodiment 2 is explained. FIG. 18 and FIG. 19 are a portion of an example of a flowchart for explaining the flow of the relay process in the present embodiment 2 and another portion of this flowchart, respectively. This relay process is started with the reception of a data frame as a trigger.

Meanwhile, the same numerals are assigned to the steps of the same processes as in the case of embodiment 1. Here, mainly the processes of parts that are different from the case of embodiment 1 are explained.

When it is determined that the LD matches the node ID of its node apparatus itself (step S003; YES), the data frame processing unit 33 issues an instruction to generate an ACK to the ACK processing unit 34 (step S006).

The ACK processing unit 34 that has received the generation instruction for the ACK generates an ACK, and transmits the generated ACK to the adjacent node apparatus 1 (LS) of the transmission source through the communication unit 10 (step S007). Then, the data frame processing unit 33 judges whether or not the GD matches the node ID of its node apparatus itself (step S008). That is, the data frame processing unit 33 judges whether or not the final destination of the received data frame is its node apparatus 1 itself.

When it is determined that the GD matches its node ID of the node apparatus itself (step S008; YES), the data frame processing unit 33 outputs the received data frame to the upper-level layer, and in response to the input of the data frame, the upper-level layer performs processing of the received data frame (step S009).

On the other hand, when it is determined that the GD does not match the node ID of its node apparatus 1 itself (step S008; NO), the data frame processing unit 33 compares the header and the FID table T1 (step S010), and judges whether or not there is a registration in the FID table T1 whose combination of the GD and FID matches the combination of the GD and FID of the header (step S011). That is, the data frame processing unit 33 judges whether or not the same data frame has already been received.

When it is determined that there is a registration in the FID table T1 whose combination of the GD and FID matches the combination of the GD and FID of the header (step S011; YES), the data frame processing unit 33 further judges whether or not the retry ID of the header and the node ID of its node apparatus itself match (step S701). That is, the data frame processing unit 33 judges whether or not the received data frame is a data frame that its node apparatus 1 itself has retransmitted.

When it is determined by the data frame processing unit 33 that the retry ID of the header and the node ID of its node apparatus itself match (step S701; YES), the process proceeds to the process of S014.

On the other hand, when it is determined that the retry ID and the node ID of its own node apparatus do not match (step S701; NO), the data frame processing unit 33 further judges whether or not the combination of the retry ID and the number of retries of the header matches the combination of the retry ID and the number of retries of a registration whose combination of the GD and FID matches the combination of the GD and FID of the header (step S702). That is, whether or not there is a registration in the FID table T1 that matches the combination of the GD and FID and retry ID and number of retries of the header is judged.

When it is determined that at least one of the retry ID and the number of retries does not match (step S702; NO), that is, when it is determined that the received data frame is an overlapped data frame, the data frame processing unit 33 discards the received data frame (step S004).

On the other hand, when it is determined that both the retry ID and the number of retries match (step S702; YES), or when it is determined that the retry ID of the header and the node ID of its node apparatus itself match (step S701; YES), that is, when it is determined that the received data frame is loop data, the data frame processing unit 33 issues an instruction re-select the LD to the route selecting unit 35 (step S014). Then, the process proceeds to the process after step S015 explained in embodiment 1.

In the process of step S011, when it is determined that there are no registrations in the FID table T1 whose combination of the GD and FID match the combination of the GD and FID of the header (step S011; NO), that is, when it is determined that the data frame is received for the first time, the data frame processing unit 33 executes the registration process in the FID table T1.

Specifically, the data frame processing unit 33 associates the GD and FID and retry ID and number of retries of the header and registers them in the FID table T1 (step S301). Then, the process proceeds to the process after step S102 explained in embodiment 1.

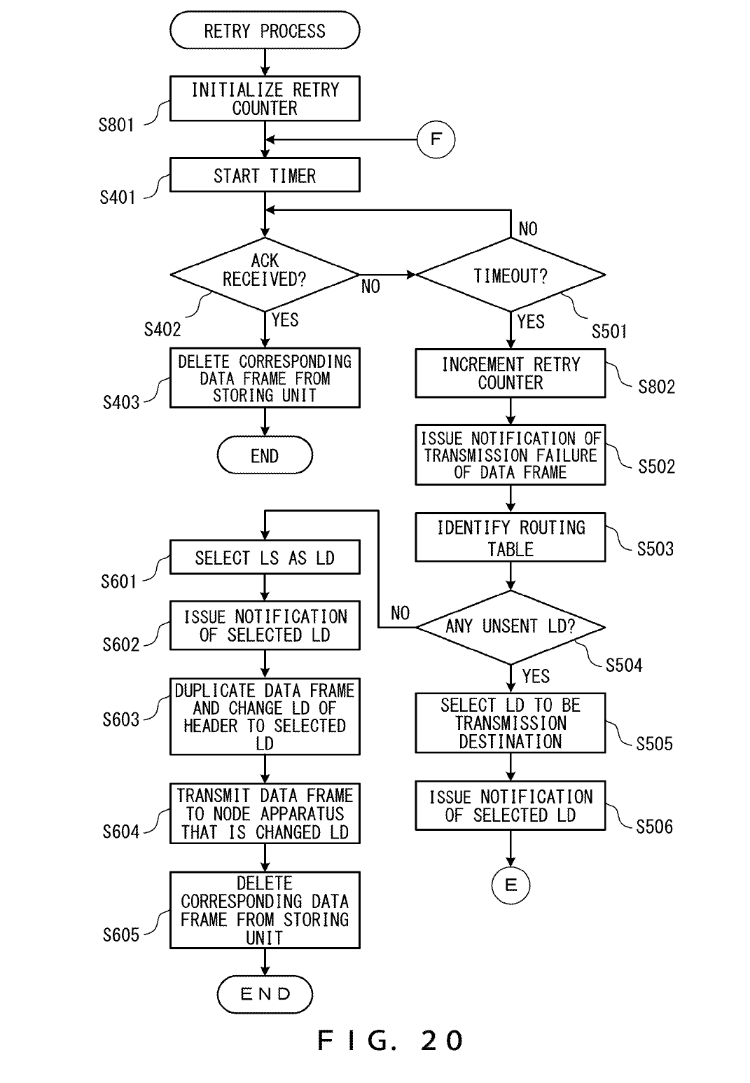

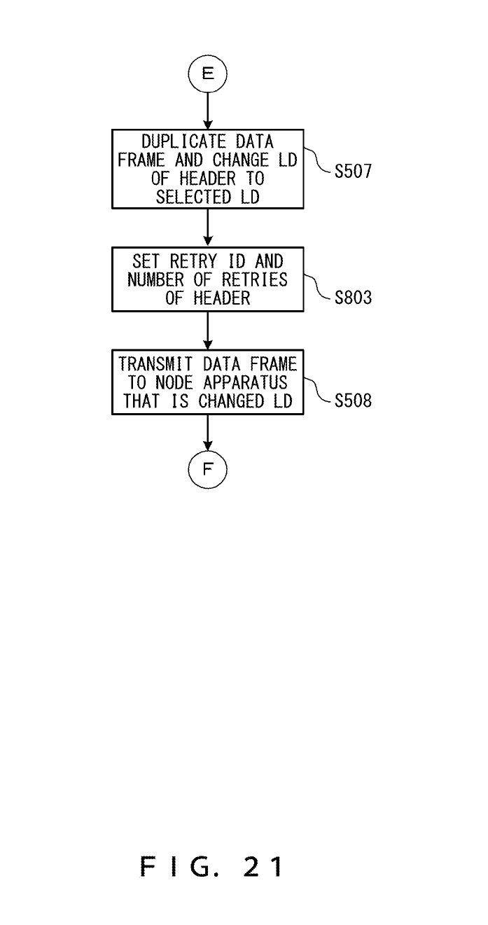

Next, referring to FIG. 20 and FIG. 21, the flow of the retry process in the present embodiment 2 is explained. FIG. 20 and FIG. 21 are a portion of an example of a flowchart for explaining the flow of the retry process in the present embodiment 2 and another portion of this flowchart, respectively. This retry process is started with the transmission of a data frame as a trigger.

Meanwhile, the same numerals are assigned to the steps of the same processes as in the case of embodiment 1. Here, mainly the processes of parts that are different from the case of embodiment 1 are explained.

When a data frame is transmitted by the data frame processing unit 33, the ACK processing unit 34 initializes the retry counter 37 (step S801), and also starts a timer (not illustrated in the drawing) (step S401), and judges whether or not an ACK sent back from the adjacent node apparatus 1 (LD) that is the transmission destination of the data frame has been received (step S402).

When it is determined that the ACK has been received (step S402; YES), the ACK processing unit 34 deletes the corresponding data frame stored in the data area of the storing unit 20 (step S403), and since the transmission of the data frame has been successful, the retry process is terminated.

On the other hand, when it is determined that the ACK has not been received yet (step S402; NO), the ACK processing unit 34 further judges whether or not a timeout has occurred (step S501). When it is determined that the timeout has not occurred yet (step S501; NO), the process returns to the process of step S402 to repeat the process described above.

On the other hand, when it is determined that the timeout has occurred (step S501; YES), the ACK processing unit i34 determines that the transmission of the data frame has failed, increments the retry counter 37, and also, notifies the data frame processing unit 33 and the route selecting unit 35 that the transmission of the data frame has failed (step S502). At this time, the ACK processing unit 34 notifies the link managing unit 32 of the judgment as to whether the transmission of the data frame has been successful. By doing so, it becomes possible for the link managing unit 32 to change the priority of the routing table T2 on the basis of whether or not the transmission of the data frame has been successful.

The route selecting unit 35 that has received the notification of the transmission failure of the data frame identifies the routing table T2 corresponding to the GD of the data frame that is the transmission target (step S503), and judges whether or not there is any “LD candidate” to which the data frame that is the transmission target (step S504).

When it is determined that there is still an “LD candidate” to which the data frame that is the transmission target (step S504; YES), the route selecting unit 35 selects the LD (step S505) and notifies the data frame processing unit 33 of the selected LD (step S506).

When a notification of the failure of the transmission of the data frame is issued from ACK processing unit 34, and further, a notification of the selected LD is issued from the route selecting unit 35, the data frame processing unit 33 duplicates the corresponding data frame stored in the data area of the storing unit 20, and changes the LD of the duplicated data frame to the LD selected by the route selecting unit 35 (step S507).

Furthermore, the data frame processing unit 33 sets the node ID of its node apparatus itself to the retry ID of the duplicated data frame, and also, as the number of retries, sets the counter value of the retry counter 37 (step S803).

Then, the data frame processing unit 33 transmits the duplicated data frame to the adjacent node apparatus 1 that is the LD after the change, through the communication unit 10 (step S508), and the process returns to the process in step S401, and the process described above is repeated.

In the process in step S504, when it is determined that there is no more “LD candidate” to which the data frame that is the transmission target has not been transmitted (step S504; NO), the process returns to the process after step S601 explained in embodiment 1.

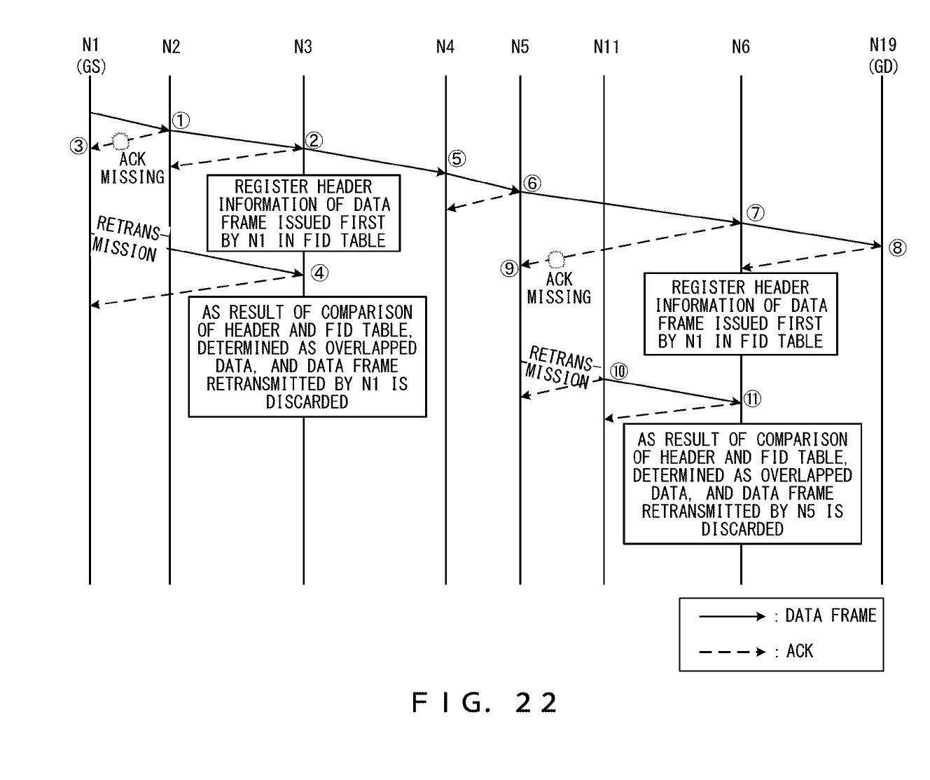

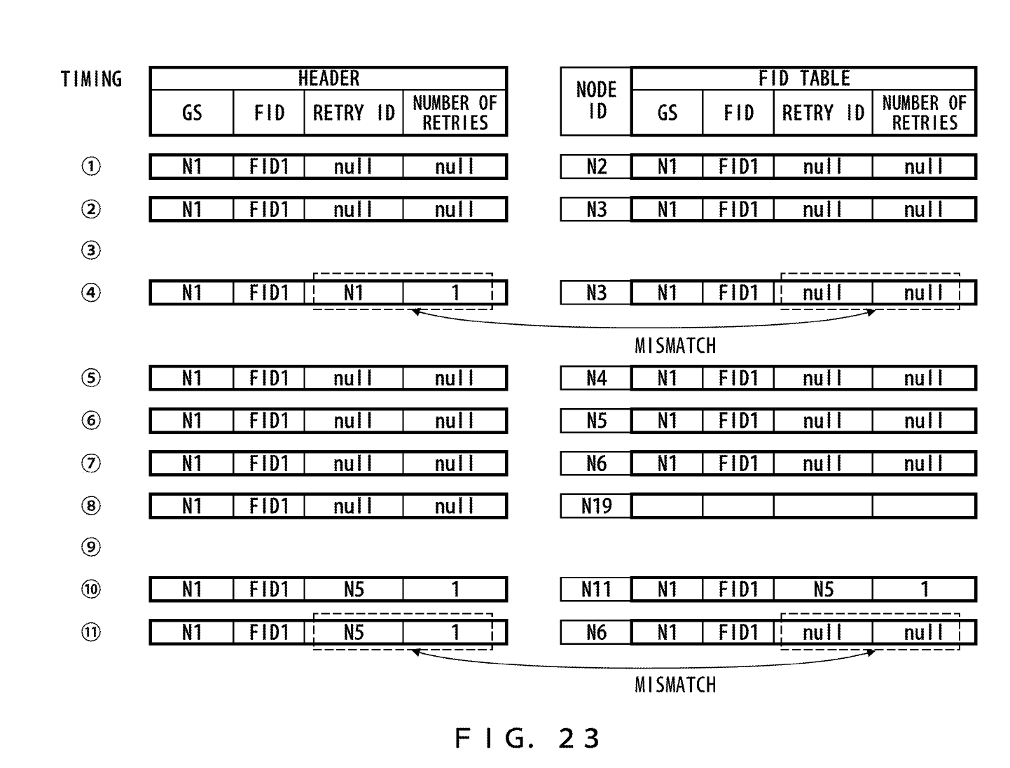

Next, referring to FIG. 6, FIG. 12, and FIG. 18 through FIG. 23, the flow of the relay process in the present embodiment 2 is explained according to the specific example. FIG. 22 is a timing chart corresponding to the example illustrated in FIG. 12. However, the circled numbers in the drawing are not necessarily the numbers assigned chronologically, but are the numbers assigned to identify the respective numbers. In addition, these numbers are supposed to be associated in FIG. 12 and FIG. 22 and FIG. 23. FIG. 23 is a diagram illustrating the contents of the header and the FID table at the respective timing of the timing chart in FIG. 22.

Meanwhile, while a plurality of different data frames may be transmitted at the same time through the network 100, here, the explanation is given focusing on the flow of the relay of one data frame. In this specific example, referring to FIG. 12 and FIG. 22, it is assumed that the original data frame transmitted from the end node apparatus N1 to the end node apparatus N2 reaches the end node apparatus N3 earlier than the data frame re-transmitted from the end node apparatus N1 to the end node apparatus N3. In addition, it is assumed that the original data frame transmitted from the end node apparatus N5 to the end node apparatus N6 reaches the end node apparatus N6 earlier than the data frame retransmitted from the end node apparatus N5 to the end node apparatus N11.

Referring to FIG. 6, FIG. 12, and FIG. 22, at the timing 1, the end node apparatus N1 generates, as the GS, a data frame with the end node apparatus N19 as the GD (the FID is FID 1), and since the priority p1> priority p2, it transmits the generated data frame to the end node apparatus N2. The GS and the FID and the retry ID and the number of retries of the data frame at the timing 1 are N1, FID 1, null, and null, respectively, as illustrated in FIG. 23.

Referring to FIG. 18, since there are no registrations in the FID table T1 whose combination of the GS and the FID match (step S011; NO), the end node apparatus N2 that has received the data frame associates the GS (N1) and the FID (FID 1) and the retry ID (null) and the number of retries (null) of the received data frame and registers them in the FID table T1 as illustrated in FIG. 23 (step S301).

Referring to FIG. 12 and FIG. 22, at the timing 2, the end node apparatus N2 transmits the data frame to the end node apparatus N3. The GS and the FID and the retry ID and the number of retries of the data frame at the timing 2 are, as it is the original data frame, still N1, FID 1, null, and null, respectively, as illustrated in FIG. 23.

Referring to FIG. 18, since there are no registrations in the FID table T1 whose combination of the GS and the FID match (step S011; NO), the end node apparatus N3 that has received the data frame associates the GS (N1) and the FID (FID 1) and the retry ID (null) and the number of retries (null) of the received data frame, and registers them in the FID table T1 as illustrated in FIG. 23 (step S301).

Referring to FIG. 12 and FIG. 22, at the timing 3, it is assumed that, for example, due to a communication failure, the ACK sent back from the end node apparatus N2 to the end node apparatus N1 is missing.

Referring to FIG. 12 and FIG. 22, at the timing 4, since the ACK is not received, the end node apparatus N1 determines that the transmission to the end node apparatus N2 has failed (step S501 of the retry process in FIG. 20; YES), and a retransmission (retry) of the data frame is performed to the end node apparatus N3. The GS and the FID and the retry ID and the number of retries of the retransmitted data frame at the timing 4 are FID 1, N1, and “1”, respectively, since it is the first retransmission (retry) in the end node apparatus N1, as illustrated in FIG. 23.

Meanwhile, since there is a registration (N1, FID 1, null, null) in the FID table T1 of the end node apparatus N3, referring to FIG. 18 and FIG. 19, the data frame processing unit 33 makes a judgment as YES in the process of step S011, NO in the process of step S701, and NO in the process of step S702. That is, the end node apparatus N3 determines the received retransmitted data frame as overlapped data, and discards the received retransmitted data frame (step S004). As described above, it becomes possible to suppress the increase in the traffic in the entire network.

Referring to FIG. 12 and FIG. 22, the end node apparatus N3 transmits the data frame to the end node apparatus N4. The GS and the FID and the retry ID and the number of retries of the data frame at the timing 5 are, since it is the original data frame, N1, FID 1, null, and null, respectively, as illustrated in FIG. 23.

Referring to FIG. 18, since there are no registrations in the FID table T1 whose combination of the GS and the FID match (step S011; NO), the end node apparatus N4 that has received the data frame associates the GS (N1) and the FID (FID 1) and the retry ID (null) and the number of retries (null) of the received data frame, and registers them in the FID table T1 as illustrated in FIG. 23 (step S301).

Referring to FIG. 12 and FIG. 22, at the timing 6, the end node apparatus N4 transmits the data frame to the end node apparatus N5. The GS and the FID and the retry ID and the number of retries of the data frame at the timing 6 are, since it is the original data, N1, FID 1, null, and null, respectively, as illustrated in FIG. 23.

Referring to FIG. 18, since there are no registrations in the FID table T1 whose combination of the GS and the FID match (step S011; NO), the end node apparatus N5 that has received the data frame associates the GS (N1) and the FID (FID 1) and the retry ID (null) and the number of retries (null) of the received data frame, and registers them in the FID table T1 as illustrated in FIG. 23 (step S301).

Referring to FIG. 12 and FIG. 22, at the timing 7, the end node apparatus N5 transmits the data frame to the end node apparatus N6. The GS and the FID and the retry ID and the number of retries of the data frame at the timing 7 are, since it is the original data, N1, FID 1, null, and null, respectively, as illustrated in FIG. 23.

Referring to FIG. 18, since there are no registrations in the FID table T1 whose combination of the GS and the FID match (step S011; NO), the end node apparatus N6 that has received the data frame associates the GS (N1) and the FID (FID 1) and the retry ID (null) and the number of retries (null) of the received data frame, and registers them in the FID table T1 as illustrated in FIG. 23 (step S301).

Referring to FIG. 12 and FIG. 22, at the timing 8, the end node apparatus N6 transmits the data frame to the end node apparatus N19 that is the GD. The GS and the FID and the retry ID and the number of retries of the data frame at the timing 8 are, since it is the original data, N1, FID 1, null, and null, respectively, as illustrated in FIG. 23.

Referring to FIG. 18, the end node apparatus N19 that has received the data frame analyzes the header (step S002), and since the GD is the node ID of the node apparatus itself (step S008; YES), the end node apparatus N19 outputs the received data frame to the upper-level layer. The upper-level layer processes the received data frame (step S009).

Referring to FIG. 12 and FIG. 22, at the timing 9, it is assumed that, for example, due to a communication failure, the ACK sent back from the end node apparatus N6 to the end node apparatus N5 is missing.

Referring to FIG. 12 and FIG. 22, at the timing 10, since the ACK is not received, the end node apparatus N5 determines that the transmission to the end node apparatus N6 has failed (step S501 of the retry process in FIG. 20; YES), and a retransmission (retry) of the data frame is performed to the end node apparatus N1. The GS and the FID and the retry ID and the number of retries of the retransmitted data frame at the timing 10 are N1, FID 1, N5, and “1”, respectively, since it is the first retransmission (retry) in the end node apparatus N5, as illustrated in FIG. 23.

Referring to FIG. 18, since there are no registrations in the FID table T1 whose combination of the GS and FID match (step S011; NO), the end node apparatus N11 that has received the retransmitted data frame associates the GS (N1) and the FID (FID 1) and the retry ID (N5) and the number of retries (“1”) of the received retransmitted data frame, and registers them in the FID table T1, as illustrated in FIG. 23 (step S301).

Referring to FIG. 12 and FIG. 22, at the timing 11, the end node apparatus N11 transmits the retransmitted data frame to the end node apparatus N6. The GS and the FID and the retry ID and the number of retries of the data frame at the timing 11 are N1, FID 1, N5, and “1”, respectively, as illustrated in FIG. 23.

Meanwhile, since there is a registration (N1, FID 1, null, null) in the FID table T1 of the end node apparatus N6, referring to FIG. 18 and FIG. 19, the data frame processing unit 33 of the end node apparatus N6 makes a judgment of YES in the process of step S011, NO in the process of step S701, and NO in the process of step S702. That is, the end node apparatus N6 determines the received retransmitted data frame as overlapped data, and discards the received retransmitted data frame (step S004). As described above, it becomes possible to suppress the increase in the traffic in the entire network.

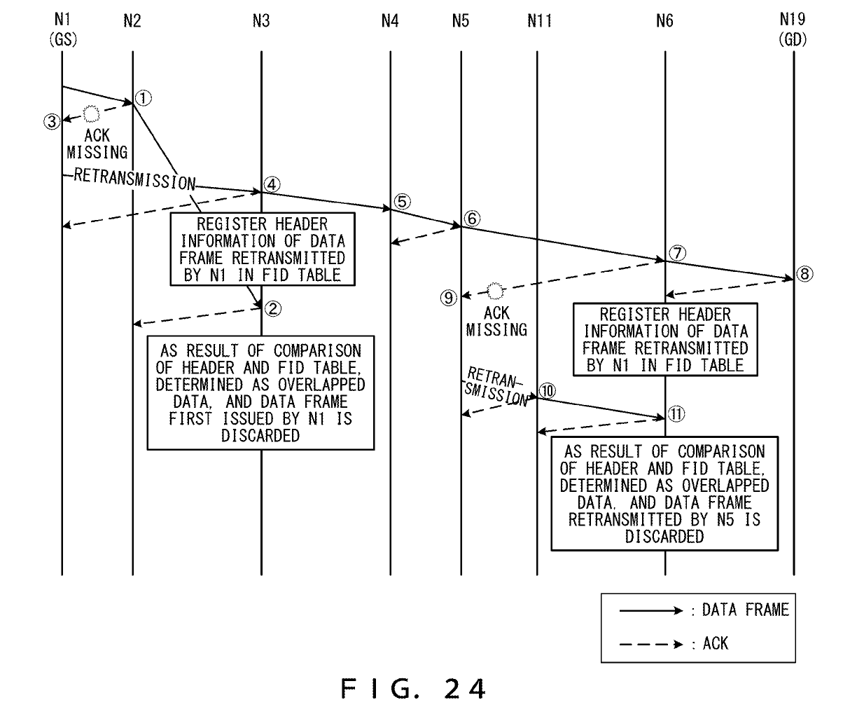

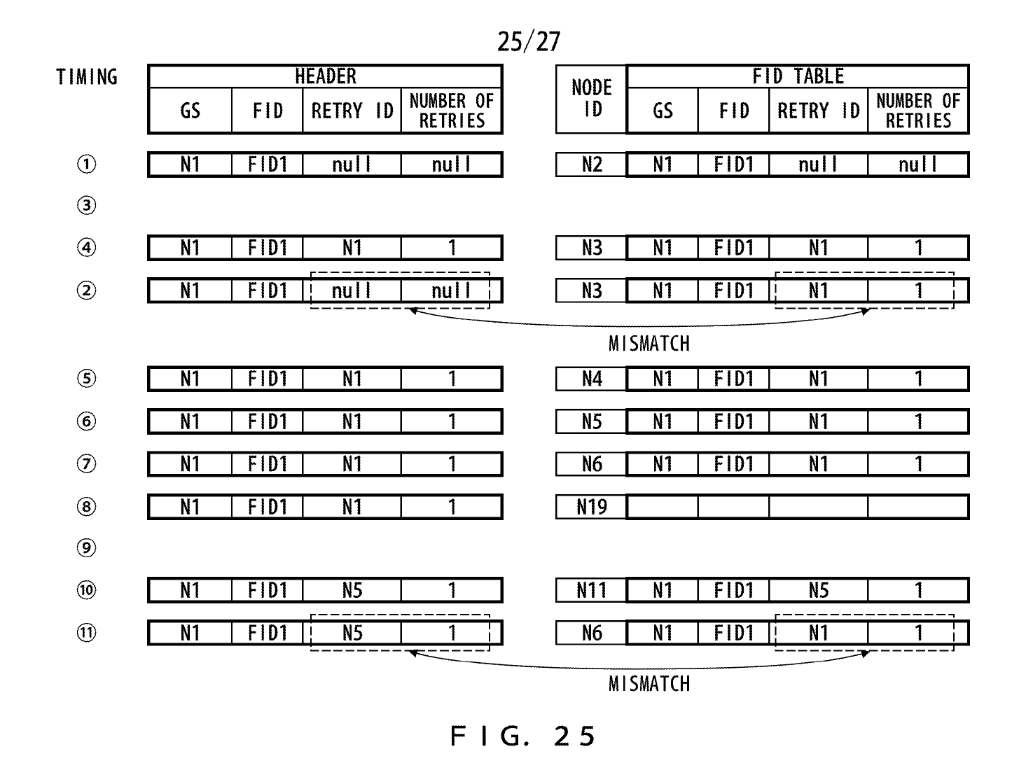

Next, referring to FIG. 6, FIG. 12, FIG. 18 through FIG. 21, FIG. 24, and FIG. 25, the flow of the relay process in the present embodiment 2 is explained according to another specific example. FIG. 24 is another timing charge corresponding to the example illustrated in FIG. 12. However, the circled numbers in the drawing are not necessarily the numbers assigned chronologically, but are the numbers assigned to identify the respective numbers. In addition, these numbers are supposed to be associated in FIG. 12, FIG. 24 and FIG. 25. FIG. 24 is a diagram illustrating the contents of the header and the FID table at the respective timing of the timing chart in FIG. 24.

Meanwhile, while a plurality of different data frames may be transmitted at the same time through the network 100, here, the explanation is given focusing on the flow of the relay of one data frame. In this specific example, referring to FIG. 12 and FIG. 24, it is assumed that the data frame retransmitted from the end node apparatus N1 to the end node apparatus N3 reaches the end node apparatus N3 earlier than the original data frame transmitted from the end node apparatus N1 to the end node apparatus N2. In addition, it is assumed that the data frame transmitted from the end node apparatus N5 to the end node apparatus N6 reaches the end node apparatus N6 earlier than the data frame transmitted from the end node apparatus N5 to the end node apparatus N11.

Referring to FIG. 6, FIG. 12, and FIG. 24, at the timing 1, the end node apparatus N1 generates, as the GS, a data frame with the end node apparatus N19 as the GD (the FID is FID 1), and since the priority p1> priority p2, the end node apparatus N1 transmits the generated data frame to the end node apparatus N2. The GS and the FID and the retry ID and the number of retries of the data frame at the timing 1 are N1, FID 1, null, and null, respectively, as illustrated in FIG. 25.

Referring to FIG. 18, since there are no registrations in the FID table T1 whose combination of the GS and the FID match (step S011; NO), the end node apparatus N2 that has received the data frame associates the GS (N1) and the FID (FID 1) and the retry ID (null) and the number of retries (null) of the received data frame and registers them in the FID table T1 as illustrated in FIG. 25 (step S301).

Referring to FIG. 12 and FIG. 24, at the timing 3, it is assumed that, for example, due to a communication failure, the ACK sent back from the end node apparatus N2 to the end node apparatus N1 is missing.

Referring to FIG. 12 and FIG. 24, at the timing 4, since the ACK is not received, the end node apparatus N1 determines that the transmission to the end node apparatus N2 has failed (step S501 of the retry process in FIG. 20; YES), and a retransmission (retry) of the data frame is performed to the end node apparatus N3. The GS and the FID and the retry ID and the number of retries of the retransmitted data frame at the timing 4 are FID 1, N1, N1, and “1”, respectively, since it is the first retransmission (retry) in the end node apparatus N1, as illustrated in FIG. 25.

Referring to FIG. 18, since there are no registrations in the FID table T1 whose combination of the GS and FID match (step S011; NO), the end node apparatus N3 that has received the retransmitted data frame associates the GS (N1) and the FID (FID 1) and the retry ID (N1) and the number of retries (“1”) of the received retransmitted data frame, and registers them in the FID table T1, as illustrated in FIG. 25 (step S301).

Referring to FIG. 12 and FIG. 24, at the timing 2, the end node apparatus N2 transmits the data frame to the end node apparatus N3. The GS and the FID and the retry ID and the number of retries of the data frame at the timing 2 are, since it is the original data, still N1, FID 1, null, and null, respectively, as illustrated in FIG. 23.

Meanwhile, since there is a registration (N1, FID 1, N1, “1”) in the FID table T1 of the end node apparatus N3, referring to FIG. 18 and FIG. 19, the data frame processing unit 33 of the end node apparatus N3 makes a judgment of YES in the process of step S011, NO in the process of step S701, and NO in the process of step S702. That is, the end node apparatus N3 determines the received retransmitted data frame to be overlapped data, and discards the received retransmitted data frame (step S004). As described above, it becomes possible to suppress the increase in the traffic in the entire network.

Referring to FIG. 12 and FIG. 24, at the timing 5, the end node apparatus N3 transmits the retransmitted data frame to the end node apparatus N4. The GS and the FID and the retry ID and the number of retries of the data frame at the timing 5 are N1, FID 1, N1, and “1” respectively, as illustrated in FIG. 25.

Referring to FIG. 18, since there are no registrations in the FID table T1 whose combination of the GS and FID match (step S011; NO), the end node apparatus N4 that has received the retransmitted data frame associates the GS (N1) and the FID (FID 1) and the retry ID (N1) and the number of retries (“1”) of the received retransmitted data frame, and registers them in the FID table T1, as illustrated in FIG. 25 (step S301).

Referring to FIG. 12 and FIG. 24, at the timing 6, the end node apparatus N4 transmits the retransmitted data frame to the end node apparatus N5. The GS and the FID and the retry ID and the number of retries of the data frame at the timing 6 are N1, FID 1, N1, and “1” respectively, as illustrated in FIG. 25.

Referring to FIG. 18, since there are no registrations in the FID table T1 whose combination of the GS and FID match (step S011; NO), the end node apparatus N5 that has received the retransmitted data frame associates the GS (N1) and the FID (FID 1) and the retry ID (N1) and the number of retries (“1”) of the received retransmitted data frame, and registers them in the FID table T1, as illustrated in FIG. 25 (step S301).

Referring to FIG. 12 and FIG. 24, at the timing 7, the end node apparatus N5 transmits the retransmitted data frame to the end node apparatus N6. The GS and the FID and the retry ID and the number of retries of the data frame at the timing 7 are N1, FID 1, N1, and “1” respectively, as illustrated in FIG. 25.

Referring to FIG. 18, since there are no registrations in the FID table T1 whose combination of the GS and FID match (step S011; NO), the end node apparatus N6 that has received the retransmitted data frame associates the GS (N1) and the FID (FID 1) and the retry ID (N1) and the number of retries (“1”) of the received retransmitted data frame, and registers them in the FID table T1, as illustrated in FIG. 25 (step S301).

Referring to FIG. 12 and FIG. 24, at the timing 8, the end node apparatus N5 transmits the retransmitted data frame to the end node apparatus N19 that is the GD. The GS and the FID and the retry ID and the number of retries of the data frame at the timing 8 are N1, FID 1, N1, and “1” respectively, as illustrated in FIG. 25.

Referring to FIG. 18, the end node apparatus N19 that has received the data frame analyzes the header (step S002), and since the GD is the node ID of the node apparatus itself (step S008; YES), outputs the received data frame to the upper-level layer. The upper-level layer processes the received data frame (step S009).

Referring to FIG. 12 and FIG. 24, at the timing 9, it is assumed that, for example, due to a communication failure, the ACK sent back from the end node apparatus N6 to the end node apparatus N5 is missing.

Referring to FIG. 12 and FIG. 24, at the timing 10, since the ACK is not received, the end node apparatus N5 determines that the transmission to the end node apparatus N6 has failed (step S501 of the retry process in FIG. 20; YES), and a retransmission (retry) of the data frame is performed to the end node apparatus N1. The GS and the FID and the retry ID and the number of retries of the retransmitted data frame at the timing 10 are FID 1, N1, N5, and “1”, respectively, since it is the first retransmission (retry) in the end node apparatus N5, as illustrated in FIG. 25.

Referring to FIG. 18, since there are no registrations in the FID table T1 whose combination of the GS and FID match (step S011; NO), the end node apparatus N1 that has received the retransmitted data frame associates the GS (N1) and the FID (FID 1) and the retry ID (N5) and the number of retries (“1”) of the received retransmitted data frame, and registers them in the FID table T1, as illustrated in FIG. 25 (step S301).

Referring to FIG. 12 and FIG. 24, at the timing 11, the end node apparatus N11 retransmits the data frame to the end node apparatus N6. The GS and the FID and the retry ID and the number of retries of the data frame at the timing 11 are N1, FID 1, N5, and “1”, respectively, as illustrated in FIG. 25.

Meanwhile, since there is a registration (N1, FID 1, N1, and “1”) in the FID table T1 of the end node apparatus N6, referring to FIG. 18 and FIG. 19, the data frame processing unit 33 of the end node apparatus N6 makes a judgment of YES in the process of step S011, NO in the process of step S701, and NO in the process of step S702. That is, the end node apparatus N6 determines the received retransmitted data frame (retransmitted by the end node apparatus N5) as overlapped data, and discards the received retransmitted data frame (step S004). As described above, it becomes possible to suppress the increase in the traffic in the entire network.

According to embodiment 2 described above, upon receiving a data frame, the node apparatus 1 judges whether or not there is a registration in the FID table T1 whose combination of the GS and FID matches, and when there is a registration that matches, on the basis of the retry ID and the number of retries, judges whether the received data frame is loop data or overlapped data.

By making the configuration as described above, it becomes possible to distinguish between overlapped data and loop data. Accordingly, it becomes possible to prevent a wrong path change due to a wrong judgment of overlapped data as loop data. Therefore, it becomes possible to prevent the disconnection of the network and the isolation of a node apparatus due to a wrong path change, making it possible to maintain an appropriate path.

In addition, according to embodiment 2 above, the node apparatus 1 discards the received data frame without transmitting it to another node apparatus 1 when the received data frame is overlapped data. By making the configuration as described above, it becomes possible to suppress the increase in the traffic in the entire network.

In addition, according to embodiment 2 described above, when a retry process occurs, the node apparatus 1 registers information indicating the date and time of occurrence, and the like, in the retry management table T3, and transmits retry information including the registered information and the node ID of the node apparatus itself to the management server. By making the configuration as described above, it becomes possible to collect information regarding the communication quality of each link of the network 100. Then, it becomes possible to maintain/manage the network 100 appropriately on the basis of the collected information.

Embodiment 3 is explained.

In embodiments 1 and 2, the configuration is made so that, when the final destination of the received data frame is the node apparatus 1 itself, that is, when the GD and the node ID of the node apparatus itself match, the node apparatus 1 does not perform the registration process in the FID table T1. In the present embodiment 3, the configuration is made so that, even when the GD and the node ID of the node apparatus itself match, the node apparatus 1 performs the registration process in the FID table T1. This configuration may be applied to both embodiments 1 and 2.

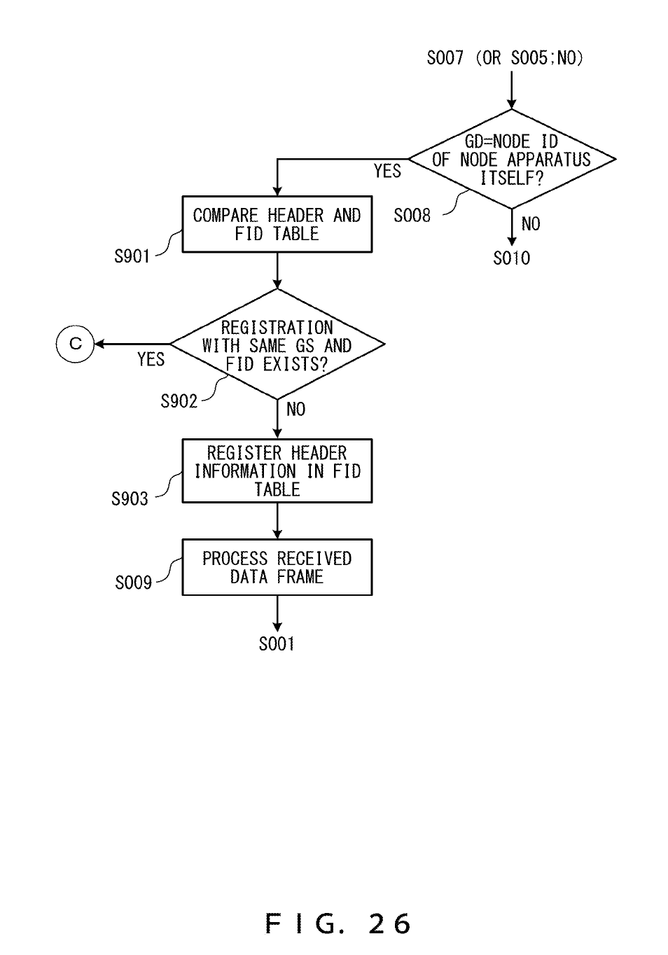

Here, referring to FIG. 26, the flow of the relay process in the present embodiment 3 is explained. FIG. 26 is a portion of an example of a flowchart for explaining the flow of the relay process in the present embodiment 3. This relay process is started as the reception of a data frame as a trigger.

In the process of step S008, the data frame processing unit 33 judges whether or not the GD and the node ID of its node apparatus itself match (step S008). That is, the data frame processing unit 33 judges whether or not the final destination of the received data frame is its node apparatus 1 itself.

When it is determined by the data frame processing unit 33 that the GD and the node ID of its node apparatus itself do not match (step S008; NO), the process proceeds to the process after step S010 explained in embodiment 1 (or 2).

On the other hand, when it is determined by the data frame processing unit 33 that the GD and the node ID of its node apparatus itself match (step S008; YES), the data frame processing unit 33 compares the header and the FID table T1 (step S901), and judges whether or not there is a registration in the FID table T1 whose combination of the GD and FID matches the combination of the GD and FID of the header (step S902). That is, the data frame processing unit 33 judges whether or not the same data frame has already been received and processed in the upper-level layer.

When it is determined that there is a registration in the FID table T1 whose combination of the GD and FID matches the combination of the GD and FID of the header (step S902; YES), that is, when it is determined that the received data frame has already been processed in the upper-level layer, the data frame processing unit 33 discards the received data frame (step S004).

On the other hand, when it is determined that there are no registrations in the FID table T1 whose combination of the GD and FID match the combination of the GD and FID of the header (step S902; NO), in the case of application to embodiment 1, the GS and the FID and the PathID of the header are associated and registered in the FID table T1 (step S903). In the case of application to embodiment 2, the GS and the FID and the retry ID and the number of retries are associated and registered in the FID table T1 (step S903).

Then, moving on to the process of step S009, the data frame processing unit 33 outputs the received data frame to the upper-level layer, and in response to the input of the data frame, the upper-level layer performs the processing of the data frame (step S009).

According to embodiment 3 described above, upon receiving the data frame whose GD matches the node ID of the node apparatus itself, the node apparatus 1 also compares the header and the FID table T1, and judges whether or not there is a registration whose combination of the GS and FID matches. Then, when there is a registration whose combination of the GS and FID matches, the node apparatus 1 discards the received data frame, and when there are no registrations whose combination of the GS and FID match, it registers the header information in the FID table T1, and also, data processing is performed in the upper-level layer. By making the configuration as described above, it becomes possible to prevent repeated execution of the processing of the same data frame. Accordingly, it becomes possible to reduce the load.

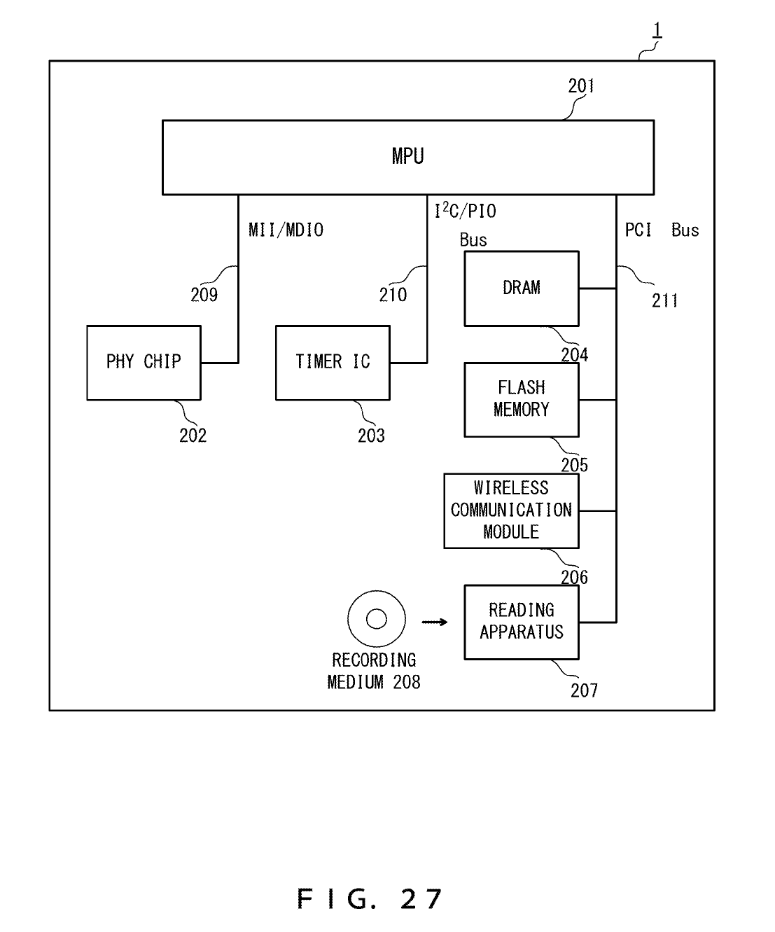

FIG. 27 is a diagram illustrating an example of the hardware configuration of the node apparatus 1 in the respective embodiments. The node apparatus 1 illustrated in FIG. 2 (or FIG. 13) may be realized by various pieces of hardware illustrated in FIG. 27, for example. In the example of FIG. 27, the node apparatus 1 includes an MPU 201, a PHY (PHYsical layer) chip 202, and a timer IC (Integrated Circuit) 203. In addition, the node apparatus 1 includes a DRAM (Dynamic Random Access Memory) 204, a flash memory 205, a wireless communication module 206, and a reading apparatus 207.

The communication interface that connects between the MPU 201 and the PHY chip 202 is an MII/MDIO (Media Independent Interface or Management Data Input/Output) 209. The MII and MDIO are both the interface between the physical layer and the MAC sublayer (Media Access Control sublayer). In addition, the MPU 201 and the timer IC 203 are connected through an I²C/PIO (Inter-Integrated Circuit or Parallel Input/Output) bus 210. Then, the DRAM 204 and the flash memory 205 and the wireless communication module 206 and the reading apparatus 207 are connected to the MPU 201 through a PCI (Peripheral Component Interconnect) bus 211.

The MPU 201 loads the operation program stored in the flash memory 205, which is a kind of a nonvolatile storing apparatus, onto the DRAM 204, and executes various processes while using the DRAM 204 as a working memory. The MPU 201 is able to realize the respective functional units of the control unit 30 illustrated in FIG. 2 (or FIG. 13) by executing the operation program.

Meanwhile, the configuration may be made so that the processes described above are executed by distributing and storing an operation program for executing the above operations in a computer-readable recording medium 208 such as a flexible disk, a CD-ROM (Compact Disk-Read Only Memory), a DVD ((Digital Versatile Disk), an MO (Magneto Optical disk) and the like, and by reading this by the reading apparatus 207 of the node apparatus 1 to install it in the computer. Furthermore, the operation program may be stored in a disk apparatus and the like that a server apparatus on the Internet has, and the operation program may be downloaded on a computer of the node apparatus 1 through the PHY chip 202 or the wireless communication module 206.

Meanwhile, depending on the embodiment, storing apparatuses of kinds other than the DRAM 204 and the flash memory 205 may be used. For example, the node apparatus 1 may include storing apparatuses such as a CAM (Content Addressable Memory), an SRAM (Static Random Access Memory), and an SDRAM (Synchronous Dynamic Random Access Memory).

The FID table T1, the routing table T2, the retry management table T3 illustrated in FIG. 2 and the like are realized by the DRAM 204, the flash memory 205, or other storing apparatuses that are not illustrated in the drawing. In addition, the flash memory 205 stores the node ID of its node apparatus itself and attribute information of its node apparatus itself (for example, information indicating the type of the node apparatus) as well.

The PHY chip 202 is a circuit that performs processing of the physical layer in the wired connection. When the network 100 is a wireless network, the node apparatus 1 does not have to include the PHY chip 202. However, for the connection between the node apparatus 1 and an external network, the node apparatus 1 may include the PHY chip 202.

For example, the node apparatus 1 may include a wired LAN port compliant with the Ethernet (registered trademark) standards, and may be connected to a gateway apparatus and the like of an external network through a cable connected to the wired LAN port.

In that case, the MPU 201 may generate an Ethernet frame, and may output it to the PHY chip 202 through the MII/MDIO 209. Then, the PHY chip 202 converts the output from the MPU 201 (that is, the logic signal representing the Ethernet frame) into a signal according to the type of the cable (that is, an electric signal or an optical signal). As described above, the node apparatus 1 is able to transmit data (for example, a frame) to an external network using the PHY chip 202.

In addition, the PHY chip 202 may also convert an electric signal or an optical signal input from an external network through the cable and the wired LAN port into a logic signal, and may output it to the MPU 201 through the MII/MDIO 209. As described above, the node apparatus 1 may receive data (for example, a frame) from an external network using the PHY chip 202.

The timer IC 203 is a circuit that performs a count-up operation until a set period of time elapses and outputs an interruption signal when the set period of time elapses.

The wireless communication module 206 is hardware that performs processing of the physical layer in the wireless communication. The wireless communication module 206 includes, for example, an antenna, an ADC (Analog-to-Digital Converter), a DAC (Digital-to-Analog Converter), a modulator, a demodulator, an encoder, a decoder and the like.

Meanwhile, depending on the embodiment, the hardware configuration of the node apparatus 1 may be different from FIG. 27, and hardware other than the standards and types illustrated in FIG. 27 may be applied to the node apparatus 1.

For example, the respective functional units of the control unit 30 illustrated in FIG. 2 (or FIG. 13) may be realized by a hardware circuit. Specifically, instead of the MPU 201, the respective functional units of the control unit 30 illustrated in FIG. 2 (or FIG. 13) may be realized by a reconfigurable circuit such as an FPGA (Field Programmable Gate Array) and an ASIC (Application Specific Integrated Circuit) and the like. Of course, these functional units may be realized by both the MPU 201 and the hardware circuit.

Some embodiment are explained above. However, embodiments are not limited to the embodiments described above, and are to be understood as including various modified forms and alternative forms of the embodiments described above. For example, it is to be understood that various embodiments may be embodied with modification of the constituent elements without departing from their spirit and scope. In addition, it is to be understood that by combining a plurality of constituent elements disclosed in the embodiments described above as needed, various embodiments may be formed. Furthermore, it is to be understood by persons skilled in the art that various embodiments may be implemented by deleting or replacing some of the constituent elements from the entirety of constituent elements illustrated in the embodiments, or by adding some constituent elements to the constituent elements described in the embodiments.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A node apparatus comprising:
a receiving unit which receives a data frame from one of a plurality of adjacent node apparatuses with which links exist;
a storing unit which stores an identification information management table in which frame identification information with which the data frame may be uniquely identified, and overlapped data identification information with which, when data frames having the same frame identification information are received in an overlapped manner, the data frame received first among the overlapped data frames may be uniquely identified, are associated;
a processor which performs a process including:
first judging whether or not a final destination of the received data frame is the node apparatus itself;
second judging, when the final destination of the received data frame is not the node apparatus itself, whether or not a registration that matches the frame identification information of the received data frame exists in the identification information management table;
third judging, when it is determined by the second judging that the registration exists in the identification information management table, whether or not the overlapped data identification information of the received data frame and the overlapped data identification information corresponding to the registration match; and
discarding the received data frame when a judgment of a mismatch is made by the third judging; and
performing a retransmission of the received data frame to another adjacent node that has not been a transmission destination of the data frame, when a judgment of a match is made by the third judging.

2. The node apparatus according to claim 1, wherein
the node apparatus itself is a relay node apparatus exclusively for relaying; and
the overlapped data identification information is apparatus identification information with which the relay node apparatus that the data frame first goes through may be uniquely identified.

3. The node apparatus according to claim 2,
wherein the process further includes
registering the frame identification information and the overlapped data identification information of the received data frame, when the second judging makes a judgment that the registration does not exist in the identification information management table.

4. The node apparatus according to claim 3,
wherein the process further includes
fourth judging, when the second judging makes a judgment that the registration does not exist in the identification information management table, whether or not setting of the overlapped data identification information of the received data frame has already been made,
wherein
when the fourth judging makes a judgment that the setting has not been made, the registering sets the apparatus identification information of its node apparatus itself as the overlapped data identification information of the received data frame, and also associates and registers, in the identification information management table, the frame identification information of the received data frame and the apparatus identification information of its node apparatus itself.

5. The node apparatus according to claim 1, wherein
the overlapped data identification information is a combination of apparatus identification information with which the node apparatus that issues the overlapped data frames may be uniquely identified, and a number of retransmissions information that indicates a number of issuances of the overlapped data frames by the node apparatus.

6. The node apparatus according to claim 5,
wherein the process further includes
registering the frame identification information and the overlapped data identification information of the received data frame, when the second judging makes a judgment that the registration does not exist in the identification information management table.

7. The node apparatus according to claim 1,
wherein the process further includes:
fifth judging, when the final destination of the received data frame is the node apparatus itself, whether or not a registration that matches the frame identification information of the received data frame exists in the identification information management table; and
second registering at least the frame identification information of the received data frame in the identification information management table, when a judgment is made by the fifth judging that the registration does not exist in the identification information management table,
wherein
the discarding discards the received data frame when a judgment is made by the fifth judging that the registration exists in the identification information management table.

8. The node apparatus according to claim 1,
wherein the process further includes
sixth judging whether or not, from the adjacent node apparatus that is a transmission destination of a transmitted data frame, a reception notification of a reception of the data frame has been received,
wherein
the performing a retransmission performs a retransmission of the transmitted data frame to an adjacent node apparatus that has not been the transmission destination, when a judgment is made by the sixth judging that the reception notification has not been received.

9. The node apparatus according to claim 8,
wherein the process further includes
generating, at a prescribed timing, retry information including a combination of information indicating a date and a time of the retransmission and apparatus identification information with which the adjacent node apparatus to which the retransmission is performed may be uniquely identified, and the apparatus identification information of the node apparatus itself, and transmitting the generated retry information to an upper-level apparatus.

10. A data relay method comprising:
receiving a data frame from one of a plurality of adjacent node apparatuses with which links exist by using a computer;
first judging whether or not a final destination of the received data frame is the node apparatus itself by using the computer;
second judging, when the final destination of the received data frame is not the node apparatus itself, whether or not a registration that matches a frame identification information of the received data frame exists in an identification information management table in which frame identification information with which the data frame may be uniquely identified, and overlapped data identification information with which, when data frames having the same frame identification information are received in an overlapped manner, the data frame received first among the overlapped data frames may be uniquely identified, are associated by using the computer;
third judging, when it is determined by the second judging that the registration exists in the identification information management table, whether or not the overlapped data identification information of the received data frame and the overlapped data identification information corresponding to the registration match by using the computer;
discarding the received data frame when the overlapped data identification information of the received data frame and the overlapped data identification information corresponding to the registration do not match by using the computer; and
performing a retransmission of the received data frame to another adjacent node that has not been a transmission destination of the data frame, when the overlapped data identification information of the received data frame and the overlapped data identification information corresponding to the registration match by using the computer.

11. A non-transitory computer-readable recording medium having stored therein a program for causing a computer of a node apparatus to execute a process comprising:
receiving a data frame from one of a plurality of adjacent node apparatuses with which links exist;
first judging whether or not a final destination of the received data frame is the node apparatus itself;
second judging, when the final destination of the received data frame is not the node apparatus itself, whether or not a registration that matches a frame identification information of the received data frame exists in an identification information management table in which frame identification information with which the data frame may be uniquely identified, and overlapped data identification information with which, when data frames having the same frame identification information are received in an overlapped manner, the data frame received first among the overlapped data frames may be uniquely identified, are associated;
third judging, when it is determined by the second judging that the registration exists in the identification information management table, whether or not the overlapped data identification information of the received data frame and the overlapped data identification information corresponding to the registration match;
discarding the received data frame when the overlapped data identification information of the received data frame and the overlapped data identification information corresponding to the registration do not match; and
performing a retransmission of the received data frame to another adjacent node that has not been a transmission destination of the data frame, when the overlapped data identification information of the received data frame and the overlapped data identification information corresponding to the registration match.
